(19) United States
(12) Patent Application Publication
(10) Pub. No.: US 2024/0107511 A1
(43) Pub. Date: Mar. 28, 2024

(54) MULTIPLE CARRIER TRANSMISSION

(71) Applicant: ZTE Corporation, Shenzhen (CN)

(72) Inventors: Chunli LIANG, Shenzhen (CN); Xingguang WEI, Shenzhen (CN); Jing SHI, Shenzhen (CN); Xianghui HAN, Shenzhen (CN)

(73) Assignee: ZTE Corporation, Shenzhen (CN)

(21) Appl. No.: 18/532,625

(22) Filed: Dec. 7, 2023

Related U.S. Application Data
(63) Continuation of application No. PCT/CN2022/082744, filed on Mar. 24, 2022.

(51) Int. Cl. H04W 72/0453

(52) U.S. Cl. CPC H04W 72/0453

(57) ABSTRACT

Wireless transmission methods and corresponding apparatus, non-transitory computer readable storage medium, and digital products are disclosed. A wireless communication method includes transmitting a first one-port uplink transmission on at least one of carriers on two corresponding bands by a user equipment (UE), wherein the UE is under an operation state in which a two-port transmission cannot be supported in the two corresponding bands; withholding uplink transmission from the UE for a time period before a second one-port or two-port uplink transmission is established on one or more other carriers associated with another band other than the two corresponding bands; establishing the second one-port or two-port second uplink transmission on the one or more other carriers associated with the another band other than the two corresponding bands; and resuming uplink transmission after the time period.

### RELATED APPLICATION

This application is a continuation of International Patent Application No. PCT/CN2022/082744, filed on Mar. 24, 2022, which is incorporated by reference with its entirety.

### TECHNICAL FIELD

This disclosure is directed generally to wireless communications.

### BACKGROUND

The world is increasingly connected the advancement in wireless communication technology. As compared to the existing wireless networks, next generation wireless communication systems may support a much wider range of functions and applications. For example, support for higher data-rates, large number of connections, ultra-low latency, and high reliability may be desired. Efficient utilization of wireless communication bands is critical for supporting the various communication functions.

### SUMMARY

Techniques are disclosed for facilitating transmission on multiple carriers.

In one exemplary aspect, this disclosure provides a wireless communication method, including:
transmitting a first one-port uplink transmission on at least one of carriers on two corresponding bands by a user equipment (UE), wherein the UE is under an operation state in which a two-port transmission cannot be supported in the two corresponding bands;
withholding uplink transmission from the UE for a time period before a second one-port or two-port uplink transmission is established on one or more other carriers associated with another band other than the two corresponding bands;
establishing the second one-port or two-port second uplink transmission on the one or more other carriers associated with the another band other than the two corresponding bands; and
resuming uplink transmission after the time period.

In yet another exemplary aspect, this disclosure provides a wireless communication method, including:
receiving a first one-port uplink transmission on at least one of carriers on two corresponding bands between a user equipment (UE) and a base station (BS), wherein the UE is under an operation state in which two-port transmission cannot be supported in the two corresponding bands; and
receiving a second one-port or two-port uplink transmission on one or more other carriers associated with another band other than the two corresponding bands after a time period when the UE withheld an uplink transmission.

In yet another exemplary aspect, this disclosure provides a wireless communication method, including:
establishing a current uplink transmission on at least one carrier corresponding to one band among up to three or four bands configured for a user equipment (UE); and
transmitting or receiving on one or more RRC (Radio Resource Control) parameters for determining a transmission chain configuration of the UE following the current uplink transmission.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the any methods disclosed herein.

In yet another exemplary embodiment, a wireless communication apparatus is disclosed. The apparatus comprises a memory, storing one or more instructions; and one or more processor, when executing the one or more processors, configured to cause the wireless communication apparatus to perform any one of the methods disclosed herein.

In yet another exemplary embodiment, this disclosure provides a non-transitory computer readable storage medium, storing one or more instructions, when being executed by one or more processors, causing a wireless communication apparatus to perform any one of the methods disclosed herein.

The above and other aspects and their implementations are described in greater detail in the drawings, the descriptions, and the claims.

### BRIEF DESCRIPTION OF THE DRAWING

FIG. 1 shows an example wireless communication network using wireless transmission bands;

FIG. 2 shows a flow chart according to one embodiment of a wireless communication method;

FIG. 3 shows a flow chart according to one embodiment of a wireless communication method;

FIGS. 4 to 10 show transmission chain switches between different transmission chain configurations;

FIG. 11 shows a flow chart according to one embodiment of a wireless communication method;

FIGS. 12-16 show transmission chain switches between different transmission chain configurations;

FIGS. 17-18 show transmission chain switches between different transmission chain configurations when 4 bands are configured; and

FIG. 19 shows a system structure of the wireless communication device that can implement any method as described in this disclosure.

### DETAILED DESCRIPTION

In wireless communication networks, e.g., NR (New Radio) or other wireless systems, a base station (BS) configures carriers for User Terminal (UE) based on UE's capabilities. The number of configured carriers for UE should not exceed UE's capabilities. Additionally, the BS also configures the UE's transmission chain (Tx chain or Tx antenna). As more spectra are allocated or re-purposed for NR, it is common for one operator to have permission or license to operate in more than one frequency band, e.g. two or more frequency bands. Each frequency band can include one or more frequencies, and a frequency band can be referred to as a band. Each band may include one or more carriers. The support for multiple frequency bands can increase the implementation complexity and cost for UE and BS. Technical solutions are provided in this disclosure to efficiently utilize these frequency bands and to solve technical problems encountered when implementing transmission with more than two bands.

The example headings for the various sections below are used to facilitate the understanding of the disclosed subject matter and do not limit the scope of the claimed subject matter in any way. Accordingly, one or more features of one example section can be combined with one or more features of another example section. Furthermore, the fifth-generation (5G) terminology is used at times for clarity of explanation. However, the techniques and implementations disclosed in the present document are not limited to 5G technology only, and may be used in wireless systems that implemented other protocols.

### Transmission Chain Configurations

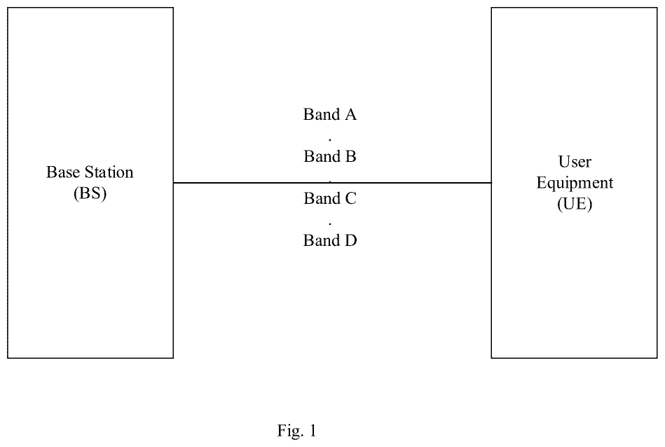

As shown in FIG. 1, a UE and a BS may establish three or more transmission chains therebetween. The term “transmission chain” or “Tx chain” refers to a transmission antenna (or transmission antenna port) and RF components (such as mixers, amplifiers, digital-to-analog convertors, and the like) for wireless transmission. At times, they may be alternative referred to as antenna chain or antenna port. The first embodiment of this disclosure introduces a scheme to support Tx (transmission) antenna switching between transmission chain configurations involving three bands for UE with 2 Tx antennas. Such switching is alternatively referred to as uplink switching. Six example cases (transmission chain configuration) that may be switched to and from are illustrated in Table 1 below:

TABLE 1

Number of transmission chains in different bands

| | Band A | Band B | Band C |
|---|---|---|---|
| Case 1-1 | 1 | 1 | 0 |
| Case 1-2 | 0 | 1 | 1 |
| Case 1-3 | 1 | 0 | 1 |
| Case 2-1 | 2 | 0 | 0 |
| Case 2-2 | 0 | 2 | 0 |
| Case 2-3 | 0 | 0 | 2 |

In this example, the cases 1-1, 1-2, and 1-3 assign each one of two transmission chains associated with a total to two antennas to one of the three bands established for wireless transmission. For example, in Case 1-1, Band A is assigned with one transmission chain (or Tx antenna or Tx antenna port), Band B is also assigned with one transmission chain, and Band C is not assigned with any transmission chain. In cases 2-1, 2-2, and 2-3, two transmission chains are assigned to the same band in either Band A, Band B, or Band C.

In another embodiment illustrated in Table 2 below, two transmission chains are assigned among four transmission Bands A to D. There are ten possible transmission chain configurations. For example, in cases 1-1, 1-2, 1-3, 1-4, 1-5, and 1-6 two transmission chains is assigned to two bands among the four bands in total. Particularly in Case 1-1, there are one transmission chain assigned to Band A, one transmission chain assigned to Band B, and no transmission chain assigned to Band C and Band D. In another implementation, such as in cases 2-1, 2-2, 2-3, and 2-4, the BS can configure the UE to have two transmission chains assigned to a same band, either Band A, B, C, or D.

TABLE 2

| | Number of transmission chains in different bands | | | |
|---|---|---|---|---|
| | Band A | Band B | Band C | Band D |
| Case 1-1 | 1 | 1 | 0 | 0 |
| Case 1-2 | 0 | 1 | 1 | 0 |
| Case 1-3 | 0 | 0 | 1 | 1 |
| Case 1-4 | 1 | 0 | 0 | 1 |
| Case 1-5 | 1 | 0 | 1 | 0 |
| Case 1-6 | 0 | 1 | 0 | 1 |
| Case 2-1 | 2 | 0 | 0 | 0 |
| Case 2-2 | 0 | 2 | 0 | 0 |
| Case 2-3 | 0 | 0 | 2 | 0 |
| Case 2-4 | 0 | 0 | 0 | 2 |

Generally speaking, the BS can configure the UE to have two transmission chains assigned separately among two of either three transmission bands or four transmission bands. Alternatively, the BS can configure the UE to have two transmission chains assigned to the same band.

Additionally, UE can switch between the above cases, referred to as transmission chain switching, and different uplink transmissions can be supported in different cases. For example, in Case 1-1, the UE can support 1-port uplink transmission on Band A and/or Band B. The UE can support 1-port or 2-port uplink transmission on the Band A in Case 2-1 (where two transmission chains are assigned to Band A). Table 1 and Table 2 list possible configurations of transmission chains among multiple bands.

The BS may configure the UE using a parameter referred to as “uplinkTxSwitchingOption” to operate in, for example, a “switchUL” or a “dualUL” mode. Under the dualUL mode, the uplink transmission of the UE can be performed on one or more bands, but under the “switchUL” mode, the uplink transmission can be performed on either one band of bands A, B, C, or D. For the switchedUL mode, the UE needs a switching period (to halt transmission and perform transmission chain switching) for switching between 1-port uplink transmission on one carrier and another 1-port uplink transmission on another carrier. For the “dualUL” mode, the UE may not need any switching period for switching between 1-port uplink transmission on one carrier on one band and another 1-port uplink transmission on another carrier on another band if both of the said bands are respectively assigned with one transmission chain. Based on the setting, it is possible that a UE only uses some or a subset of the configurations in Table 1 and Table 2.

### Transmission Chain Configuration Switching

In one implementation, the BS configures and indicates the number of active UL carriers from the three or four bands to the UE. Unless new indication from the base station is further received, UE may transmit subsequent uplink transmission on the current uplink carriers. Whether to transmit uplink transmission on one of the available uplink carriers or more than one uplink carriers depends on the scheduling command and RRC configuration. Once UE receives a new indication of uplink carriers for the subsequent transmissions, a switching period may be needed. UE is not required to transmit during the switching period.

Specifically, the UE may be configured to withhold the transmission during a switching period in the following scenarios.

Scenarios 1: The UE switches from a 1-port transmission on one carrier on one band to a 2-port transmission on another carrier on another band. For example, the UE may switch from Case 1-2 to Case 2-1. The change of the transmission chain configuration may lead to the switching duration when the uplink transmission of the UE may be withheld.

Scenario 2: The UE switches from a 2-port transmission on one carrier on one band to a 1-port transmission on another carrier on another band. For example, the UE may switch from Case 2-1 to Case 1-2, where a 2-port transmission is on Band A in Case 2-1 and then the 1-port transmissions are used on Band B and Band C in Case 1-2. The change of the transmission chain configuration may lead to the switching duration when the uplink transmission of the UE may be withheld.

Scenario 3: The UE may switch from a 2-port transmission on one carrier on one band to have a 2-port transmission on another carrier on another band. For example, the UE has a 2-port transmission on Band A in Case 2-1, and the UE can switch to have a 2-port transmission on Band B in Case 2-2. The change of the transmission chain configuration may lead to the switching duration when the uplink transmission of the UE may be withheld.

Scenario 4: The UE may switch from a 1-port transmission on one carrier of one band, when the current carrier can support a 1-port but not a 2-port transmission, to have a 2-port transmission on the same band after the limitation is removed. For example, the UE may switch from Case 1-1 to Case 2-1 after the carrier of Band A supports a 2-port transmission. The change of the transmission chain configuration may lead to the switching duration when the uplink transmission of the UE may be withheld.

Scenario 5: The UE may switch from a 1-port transmission on one carrier of one band, when the current carrier supports a 1-port or 2-port transmission, to have a 1-port or 2-port transmission on another band with another carrier when the UE is configured with an operation mode of “SwitchUL”. The change of the transmission chain configuration may lead to the switching duration when the uplink transmission of the UE may be withheld.

Scenario 6: The UE may switch from a 1-port or 2-port transmission on at least one of two carriers on two bands, when a 2-port transmission is not supported by the current status of the current bands, to a 1-port or 2-port transmission on another carrier on another band other than the previous two bands. For example, the UE may switch from Case 1-1 to Case 1-2. Specifically, the UE is to transmit under a 1-port transmission on Band C (Case 1-2) and the preceding transmission was a 1-port transmission on Band A or Band B (Case 1-1). The change of the transmission chain configuration may lead to the switching duration when the uplink transmission of the UE may be withheld.

The UE may withhold the uplink transmission when one of the six switching scenarios is met.

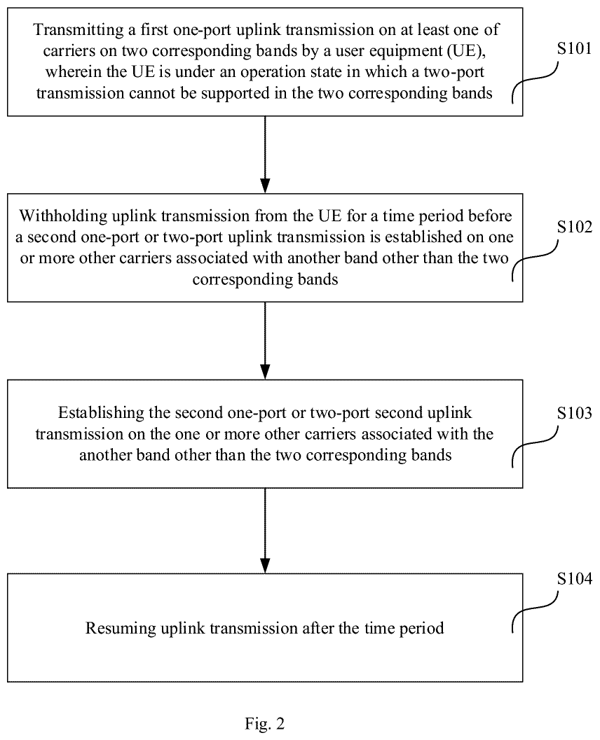

In this disclosure, an example wireless communication method is disclosed as shown in FIG. 2. This method may include the example steps below and performed by a UE.

S101: transmitting a first one-port uplink transmission on at least one of carriers on two corresponding bands by a user equipment (UE), wherein the UE is under an operation state in which a two-port transmission cannot be supported in the two corresponding bands;

S102: withholding uplink transmission from the UE for a time period before a second one-port or two-port uplink transmission is established on one or more other carriers associated with another band other than the two corresponding bands;

S103: establishing the second one-port or two-port second uplink transmission on the one or more other carriers associated with the another band other than the two corresponding bands; and

S104: resuming uplink transmission after the time period.

From the BS side, the BS may correspondingly perform the steps including:

S201: receiving a first one-port uplink transmission on at least one of carriers on two corresponding bands between a user equipment (UE) and a base station (BS), wherein the UE is under an operation state in which a two-port transmission cannot be supported on the two corresponding bands; and

S202: receiving a second one-port or two-port uplink transmission on one or more carriers associated with another band other than the two corresponding bands after a time period when the UE withheld an uplink transmission.

The operation state can be determined by a parameter referred to as uplinkTxSwitching-DualUL-TxState. The UE may assume the operation state based on this parameter. For example, if this parameter is configured to TwoTxOnBandX, the UE may assume it is under an operation state that a 2-port transmission can be supported on band X by the UE. And at the same time, the UE should also assign the two transmission chains to band X.

When UE withholds the uplink transmission, the transmission chain configuration switching can be performed during the withholding time period. For example, the UE may switch one transmission chain from Band A to Band B. The UE may alternatively switch 2 transmission chains from Band A to Band B. These switches can be performed during the withholding time period to prevent transmission loss.

### Transmission Configuration and Mapping

The different embodiments below exemplarily list the transmission chain configurations of the UE under different conditions.

### Embodiment 1-1

In this implementation, the transmission switching option parameter uplinkTxSwitchingOption is set to switchUL, and Band A is limited to have at most one transmission chain. Under the switchUL mode, the uplink transmission can be performed either on one band of bands A, B, or C. Under this condition, the possible combinations of number of antenna ports for uplink transmission for some of the entries in Table 1 are listed in the Table 3 below. The column “number of transmission chains” shows the number of the transmission chains in different configurations. The column “number of antenna port for uplink transmission” is the possible combination of number of antenna ports for uplink transmission for the corresponding carrier with the transmission chain configurations at the same row. The number of transmission chain is assigned on a band-by-band basis, while the number of antenna ports is assigned on a carrier-by-carrier basis on the corresponding band. An entry with “1T” means one transmission chain is assigned to the corresponding band, and “2T” means two transmission chains are assigned to the corresponding band. “0T” means no transmission chain is assigned to the corresponding band. The indication of “1P” and “2P” means that 1-port and 2-port transmission can be supported for the uplink transmission on the carrier on the band respectively. “0P” means no transmission takes place on the carrier on the band. If “1T” is assigned to one band, 1-port transmission can be supported on the carrier(s) of the corresponding band. When “2T” is assigned to one band, both 1-port and 2-port transmission can be supported on the carrier(s) of the corresponding band.

For clarification, in Case 2-2, Band A and Band C are assigned no transmission chain while Band B is assigned with 2 transmission chains. Also, each band supports one carrier, either carrier 1, 2, or 3. In this condition for example, under the configuration of Case 2-2, 2-port transmission can be supported on Carrier 2 on Band B and no other transmission is transmitted on Band A and Band C, as indicated as 0P+2P+0P in Table-3. Alternative, 1-port transmission can also be supported on Carrier 2 on Band B, and no other transmission is supported on Band A and Band C, as indicated as 0P+1P+0P in Table 3. This convention is followed in this disclosure.

TABLE 3

| | | | Number of Antenna Port for uplink transmission | | |
|---|---|---|---|---|---|
| Number of Transmission Chains | | | Band A | Band B | Band C |
| Band A | Band B | Band C | Carrier 1 | Carrier 2 | Carrier 3 |

| | | | | |
|---|---|---|---|---|
| Case 1-1 | 1 T | 0 T or 1 T | 0 T | 1 P + 0 P + 0 P |
| Case 2-2 | 0 T | 2 T | 0 T | 0 P + 2 P + 0 P or 0 P + 1 P + 0 P |
| Case 2-3 | 0 T | 0 T | 2 T | 0 P + 0 P + 2 P or 0 P + 0 P + 1 P |

### Embodiment 1-2

In this implementation, the uplinkTxSwitchingOption may be set to dualUL and Band A is limited to have at most one transmission chain. Under dualUL mode, the uplink transmission can be performed on one or more bands. Under this condition, the possible combinations of the number of antenna ports for uplink transmission for some of the entries in Table 1 are listed in the Table 4 below.

In this embodiment, multiple possible uplink transmissions can be supported for each transmission chain configuration. For example, under the transmission chain configuration of Case 1-1, the UE can implement three uplink transmissions including 1P+0P+0P (1-port transmission on Carrier 1 on Band A and no transmission on Band B and Band C) or 1P+1P+0P (1-port transmission on Carrier 1 on Band A, 1-port transmission on Carrier 2 on Band B, and no transmission on Band C) or 0P+1P+0P (no transmission on Band A, 1-port transmission on Carrier 2 on Band B, and no transmission on Band C). Additionally, same uplink transmission can be supported under different transmission chain configurations. For example, the uplink transmission of 1P+0P+0P (1-port transmission on Carrier 1 on Band A and no transmission on Band B and Band C) can be supported under transmission chain configuration of Case 1-1 and Case 1-3.

In this embodiment, if the UE is to transmit a 1-port transmission on Carrier 2 on Band B and the preceding transmission was a 1-port transmission on Carrier 1 on Band A or a 1-port transmission on Carrier 3 on Band C under the operation state that 2-port transmission was not supported on Band A and C, i.e., under the operation state in Case 1-3, then at least one transmission chain from Band A or Band C should be switched to Band B for the current transmission on Band B. During this switching, a switching gap is introduced, and the UE is not expected to transmit for a duration of the switching gap on any of the carriers on any of the bands. Similar thing would happen if the UE is to transmit a 1-port transmission on Band A and the preceding transmission was under the operation state of Case 1-2, or if the UE is to transmit a 1-port transmission on Band C and the preceding transmission was under the operation state of Case 1-1. For all these switching cases, switching gap is introduced and the UE is not expected to transmit for a duration of the switching gap on any of the carriers on any of the bands. In summary, a switching gap is needed for the uplink transmission switching among Case 1-1, Case 1-2 and Case 1-3.

TABLE 4

| Number of | | | Number of Antenna Port for uplink | | |
|---|---|---|---|---|---|
| Transmission | | | transmission | | |
| Chains | | | Band A | Band B | Band C |
| Band A | Band B | Band C | Carrier 1 | Carrier 2 | Carrier 3 |

| | | | | |
|---|---|---|---|---|
| Case 1-1 | 1T | 1T | 0T | 1P + 0P + 0P or 1P + 1P + 0P or 0P + 1P + 0P |
| Case 1-2 | 0T | 1T | 1T | 0P + 1P + 0P or 0P + 1P + 1P or 0P + 0P + 1P |
| Case 1-3 | 1T | 0T | 1T | 1P + 0P + 0P or 1P + 0P + 1P or 0P + 0P + 1P |
| Case 2-2 | 0T | 2T | 0T | 0P + 2P + 0P or 0P + 1P + 0P |
| Case 2-3 | 0T | 0T | 2T | 0P + 0P + 2P or 0P + 0P + 1P |

### Embodiment 1-3

In this implementation, the uplinkTxSwitchingOption may be set to switchUL and each band is associated with either 2 transmission chains or no transmission chain, where the band in use is assigned two transmission chains. As indicated in Table 5, either Band A, Band B, or Band C may be configured with two transmission chains. Because the number of transmission chains in total is two, the rest of the bands are not assigned with any transmission chains. Also, each band in this embodiment associates with one carrier, and the band assigned with two transmission chains can either be triggered with 1-port transmission or 2-port transmission.

TABLE 5

| Number of | | | | | |
|---|---|---|---|---|---|
| Transmission | | | Number of Antenna Port for | | |
| Chains | | | uplink transmission | | |
| Band | Band | Band | Band A | Band B | Band C |
| A | B | C | Carrier 1 | Carrier 2 | Carrier 3 |

| | | | | |
|---|---|---|---|---|
| Case 2-1 | 2T | 0T | 0T | 2P + 0P + 0P or 1P + 0P + 0P |
| Case 2-2 | 0T | 2T | 0T | 0P + 2P + 0P or 0P + 1P + 0P |
| Case 2-3 | 0T | 0T | 2T | 0P + 0P + 2P or 0P + 0P + 1P |

### Embodiment 1-4

In this implementation, the uplinkTxSwitchingOption may be set to dualUL, and each band is configured to associate with at most two transmission chains. The detailed configuration is shown in Table 6 below. For example, in Case 1-1, Band A is assigned with one transmission chain, and alternatively in Case 2-1, Band A is assigned with 2 transmission chains. In this embodiment, each of the three Bands A, B, and C may be associated with one carrier 1, 2, or 3. In this implementation, same uplink transmission can be supported under different transmission chain configurations. For example, uplink transmission of 1P+0P+0P (1 port transmission on Carrier 1 on Band A and no transmission on Band B and C) can be supported under transmission chain configurations of Case 1-1, Case 1-3, and Case 2-1. Likewise, uplink transmission of 0P+1P+0P (1 port transmission on Carrier 2 on Band B and no transmission on Band A and C) can be supported under transmission chain configurations of Case 1-1, Case 1-2, and Case 2-2.

Similar as Embodiment 1-2, in this embodiment, a switching gap is needed for the uplink transmission switching among Case 1-1, Case 1-2 and Case 1-3.

TABLE 6

| Number of | | | Number of Antenna Port for uplink | | |
|---|---|---|---|---|---|
| Transmission | | | transmission | | |
| Chains | | | Band A | Band B | Band C |
| Band A | Band B | Band C | Carrier 1 | Carrier 2 | Carrier 3 |

| | | | | |
|---|---|---|---|---|
| Case 1-1 | 1T | 1T | 0T | 1P + 0P + 0P or 1P + 1P + 0P or 0P + 1P + 0P |
| Case 1-2 | 0T | 1T | 1T | 0P + 1P + 0P or 0P + 1P + 1P or 0P + 0P + 1P |
| Case 1-3 | 1T | 0T | 1T | 1P + 0P + 0P or 1P + 0P + 1P or 0P + 0P + 1P |
| Case 2-1 | 2T | 0T | 0T | 2P + 0P + 0P or 1P + 0P + 0P |
| Case 2-2 | 0T | 2T | 0T | 0P + 2P + 0P or 0P + 1P + 0P |
| Case 2-3 | 0T | 0T | 2T | 0P + 0P + 2P or 0P + 0P + 1P |

In further embodiments below, the uplink transmission may be implemented in three bands, and one of the bands, such as Band B, is configured with two carriers while the other two bands have one carrier.

### Embodiment 2-1

In this implementation, the uplinkTxSwitchingOption may be set to switchUL and Band A is limited to associate with at most one transmission chain. Under this condition, the possible combinations of number of antenna ports for uplink transmission for some of the entries in Table 1 are listed in the Table 7 below. For example, Band A can be assigned with one or no transmission chain. If Band A is assigned with one transmission chain, the remaining one transmission chain can be assigned to Band B or Band C. If Band A is not assigned any transmission chain, two remaining transmission chains can be assigned to Band B or Band C. Correspondingly, when two transmission chains are assigned to Band B, for each of the carriers, including carrier 2 and carrier 3, 1-port and 2-port transmission can be supported on both carriers. Therefore, multiple possible uplink transmissions can be supported based on the combinations of 1-port and 2-port transmission for each of the two carriers. For example, under the configuration of Case 2-2, 2-port transmission can be supported on both Carrier 2 and Carrier 3 on Band B, as indicated with 0P+(2P+2P)+0P in Table 7, wherein no transmission is sent on Band A and Band C. Further, 1-port transmission on Carrier 2 together with 2-port transmission on Carrier 3 can also be supported on Band B, as indicated with 0P+(1P+2P)+0P in Table 7.

TABLE 7

| Number of | | | Number of Antenna Port for uplink | | | |
|---|---|---|---|---|---|---|
| Transmission | | | transmission | | | |
| Chains | | | Band A | Band B | | Band C |
| Band A | Band B | Band C | Carrier 1 | Carrier 2 | Carrier 3 | Carrier 4 |

| | | | | |
|---|---|---|---|---|
| Case 1-1 | 1T | 1T | 0T | 1P + (0P + 0P) + 0P |
| Case 2-2 | 0T | 2T | 0T | 0P + (2P + 0P) + 0P or 0P + (0P + 2P) + 0P or |
| | | | | 0P + (2P + 2P) + 0P or 0P + (1P + 0P) + 0P or |
| | | | | 0P + (0P + 1P) + 0P or 0P + (1P + 1P) + 0P or |
| | | | | 0P + (2P + 1P) + 0P or 0P + (1P + 2P) + 0P |
| Case 2-3 | 0T | 0T | 2T | 0P + (0P + 0P) + 2P or 0P + (0P + 0P) + 1P |

### Embodiment 2-2

In this implementation, the uplinkTxSwitchingOption may be set to dualUL and Band A may be limited to associate with at most one transmission chain. Under this condition, the possible configurations are listed in the Table 8 below. In this embodiment, when Band B is assigned with 1 transmission chain, the UE can, but not necessarily, be triggered with 1-port transmission in each of Carrier 2 and Carrier 3, such as the 0P+(1P+1P)+0P in Table 8 with no transmission sent on Band A and Band C under the configuration of Case 1-1. Additionally, similar to other embodiments in this disclosure, same uplink transmission can be supported under different chain configurations. For example, uplink transmission of 1P+(0P+0P)+0P may be supported under transmission chain configuration cases 1-1 and 1-3.

Similar as Embodiment 1-2, in this embodiment, a switching gap is needed for the uplink transmission switching among Case 1-1, Case 1-2 and Case 1-3.

TABLE 8

| Number of | | | Number of Antenna Port for uplink | | |
|---|---|---|---|---|---|
| Transmission | | | transmission | | |
| Chains | | | Band A | Band B | Band C |
| Band A | Band B | Band C | Carrier 1 | Carrier 2 | Carrier 3 |

| | | | | |
|---|---|---|---|---|
| Case 1-1 | 1T | 1T | 0T | 1P + (0P + 0P) + 0P or 1P + (1P + 0P) + 0P or |
| | | | | 1P + (0P + 1P) + 0P or 1P + (1P + 1P) + 0P or |
| | | | | 0P + (1P + 0P) + 0P or 0P + (0P + 1P) + 0P or |
| | | | | 0P + (1P + 1P) + 0P |
| Case 1-2 | 0T | 1T | 1T | 0P + (0P + 0P) + 1P or 0P + (1P + 0P) + 1P or |
| | | | | 0P + (0P + 1P) + 1P or 0P + (1P + 1P) + 1P or |
| | | | | 0P + (1P + 0P) + 0P or 0P + (0P + 1P) + 0P or |
| | | | | 0P + (1P + 1P) + 0P |
| Case 1-3 | 1T | 0T | 1T | 1P + (0P + 0P) + 0P or 1P + (0P + 0P) + 1P or |
| | | | | 0P + (0P + 0P) + 1P |
| Case 2-2 | 0T | 2T | 0T | 0P + (2P + 0P) + 0P or 0P + (0P + 2P) + 0P or |
| | | | | 0P + (2P + 2P) + 0P or |
| | | | | 0P + (1P + 0P) + 0P or 0P + (0P + 1P) + 0P or |
| | | | | 0P + (1P + 1P) + 0P or |
| | | | | 0P + (2P + 1P) + 0P or 0P + (1P + 2P) + 0P |
| Case 2-3 | 0T | 0T | 2T | 0P + (0P + 0P) + 2P or 0P + (0P + 0P) + 1P |

### Embodiment 2-3

In this implementation, the uplinkTxSwitchingOption may be set to switchUL and each band is associated with two assigned transmission chains. Under this condition, the possible configurations are listed in the Table 9 below.

TABLE 9

| Number of | | | Number of Antenna Port for uplink | | | |
|---|---|---|---|---|---|---|
| Transmission | | | transmission | | | |
| Chains | | | Band A | Band B | | Band C |
| Band A | Band B | Band C | Carrier 1 | Carrier 2 | Carrier 3 | Carrier 4 |

| | | | | |
|---|---|---|---|---|
| Case 2-1 | 2T | 0T | 0T | 2P + 0P + 0P or 1P + 0P + 0P |
| Case 2-2 | 0T | 2T | 0T | 0P + (2P + 0P) + 0P or 0P + (0P + 2P) + 0P or |
| | | | | 0P + (2P + 2P) + 0P or |
| | | | | 0P + (1P + 0P) + 0P or 0P + (0P + 1P) + 0P or |
| | | | | 0P + (1P + 1P) + 0P or |
| | | | | 0P + (2P + 1P) + 0P or 0P + (1P + 2P) + 0P |
| Case 2-3 | 0T | 0T | 2T | 0P + 0P + 2P or 0P + 0P + 1P |

### Embodiment 2-4

In this implementation, the uplinkTxSwitchingOption may be set to dualUL and each band must have at most two transmission chains assigned. Under this condition, the possible configurations are listed in the Table 10 below. Additionally, same uplink transmission can be supported under different chain configurations.

Similar as Embodiment 1-2, in this embodiment, a switching gap is needed for the uplink transmission switching among Case 1-1, Case 1-2 and Case 1-3.

TABLE 10

| Number of | | | Number of Antenna Port for | | | |
|---|---|---|---|---|---|---|
| Transmission | | | uplink transmission | | | |
| Chains | | | Band A | Band B | | Band C |
| Band A | Band B | Band C | Carrier 1 | Carrier 2 | Carrier 3 | Carrier 4 |

| | | | | |
|---|---|---|---|---|
| Case 1-1 | 1T | 1T | 0T | 1P + (0P + 0P) + 0P or 1P + (1P + 0P) + 0P or |
| | | | | 1P + (0P + 1P) + 0P or 1P + (1P + 1P) + 0P or |
| | | | | 0P + (1P + 0P) + 0P or 0P + (0P + 1P) + 0P or |
| | | | | 0P + (1P + 1P) + 0P |
| Case 1-2 | 0T | 1T | 1T | 0P + (0P + 0P) + 1P or 0P + (1P + 0P) + 1P or |
| | | | | 0P + (0P + 1P) + 1P or 0P + (1P + 1P) + 1P or |
| | | | | 0P + (1P + 0P) + 0P or 0P + (0P + 1P) + 0P or |
| | | | | 0P + (1P + 1P) + 0P |
| Case 1-3 | 1T | 0T | 1T | 1P + (0P + 0P) + 0P or 1P + (0P + 0P) + 1P or |
| | | | | 0P + (0P + 0P) + 1P |
| Case 2-1 | 2T | 0T | 0T | 2P + (0P + 0P) + 0P or 1P + (0P + 0P) + 0P |
| Case 2-2 | 0T | 2T | 0T | 0P + (2P + 0P) + 0P or 0P + (0P + 2P) + 0P or |
| | | | | 0P + (2P + 2P) + 0P or |
| | | | | 0P + (1P + 0P) + 0P or 0P + (0P + 1P) + 0P or |
| | | | | 0P + (1P + 1P) + 0P or |
| | | | | 0P + (2P + 1P) + 0P or 0P + (1P + 2P) + 0P |
| Case 2-3 | 0T | 0T | 2T | 0P + (0P + 0P) + 2P or 0P + (0P + 0P) + 1P |

In some embodiments below, the uplink transmission may be implemented in three bands, and two of the bands, such as Band B and Band C, may be configured with two carriers while the other two bands have one carrier.

### Embodiment 3-1

In this implementation, the uplinkTxSwitchingOption may be set to switchUL and Band A is limited to associate with at most one transmission chain. Under this condition, the possible configurations are listed in the Table 11 below. As shown in the table below, 1-port transmission or 2-port transmission can be supported on each carrier on Band B and Band C. Therefore, multiple possible uplink transmissions can be supported based on the combinations of 1-port and 2-port transmission for each of the two carriers on Band B or Band C. For example, under the configuration of Case 2-2, 2-port transmission can be supported on both Carrier 2 and Carrier 3 on Band B, as indicated with 0P+(2P+2P)+(0P+0P) in Table 11, but no transmission is sent on Band A and Band C. And 1-port transmission on Carrier 2 together with 2-port transmission on Carrier 3 can also be supported on Band B, as indicated with 0P+(1P+2P)+(0P+0P) in Table 11. Similarly, under the configuration of Case 2-3, 2-port transmission can be supported on both Carrier 4 and Carrier 5 on Band C, as indicated with 0P+(0P+0P)+(2P+2P) in Table 11, wherein no transmission is sent on Band A and Band B. And 1-port transmission on Carrier 4 together with 2-port transmission on Carrier 5 can also be supported on Band C, as indicated with 0P+(0P+0P)+(1P+2P) in Table 11.

TABLE 11

| | | | Number of Antenna Port for uplink | | | | |
|---|---|---|---|---|---|---|---|
| Number of | | | transmission | | | | |
| Transmission | | | Band | Band | | Band | |
| Chains | | | A | B | | C | |
| Band | Band | Band | Carrier | Carrier | Carrier | Carrier | Carrier |
| A | B | C | 1 | 2 | 3 | 4 | 5 |

| | | | | |
|---|---|---|---|---|
| Case | 1T | 1T | 0T | 1P + (0P + 0P) + (0P + 0P) |
| 1-1 | | | | |
| Case | 0T | 2T | 0T | 0P + (2P + 0P) + (0P + 0P) or 0P + (0P + 2P) + (0P + 0P) or |
| 2-2 | | | | 0P + (2P + 2P) + (0P + 0P) or 0P + (1P + 0P) + (0P + 0P) or |
| | | | | 0P + (0P + 1P) + (0P + 0P) or 0P + (1P + 1P) + (0P + 0P) or |
| | | | | 0P + (2P + 1P) + (0P + 0P) or 0P + (1P + 2P) + (0P + 0P) |
| Case | 0T | 0T | 2T | 0P + (0P + 0P) + (2P + 0P) or 0P + (0P + 0P) + (2P + 0P) or |
| 2-3 | | | | 0P + (0P + 0P) + (2P + 2P) or 0P + (0P + 0P) + (1P + 0P) or |
| | | | | 0P + (0P + 0P) + (0P + 1P) or 0P + (0P + 0P) + (1P + 1P) or |
| | | | | 0P + (0P + 0P) + (2P + 1P) or 0P + (0P + 0P) + (2P + 1P) |

### Embodiment 3-2

In this implementation, the uplinkTxSwitchingOption may be set to dualUL and Band A is limited to have at most one transmission chain. Under this condition, the possible configurations are listed in the Table 12 below. Additionally, similar to other embodiments in this disclosure, same uplink transmission can be supported under different chain configurations. For example, uplink transmission of 0P+(1P+1P)+(0P+0P) may be supported under transmission chain configuration Case 1-1, Case 1-2 and Case 2-2.

Similar as Embodiment 1-2, in this embodiment, a switching gap is needed for the uplink transmission switching among Case 1-1, Case 1-2 and Case 1-3.

TABLE 12

| | | | Number of Antenna Port for uplink | | | | |
|---|---|---|---|---|---|---|---|
| Number of | | | transmission | | | | |
| Transmission | | | Band | Band | | Band | |
| Chains | | | A | B | | C | |
| Band | Band | Band | Carrier | Carrier | Carrier | Carrier | Carrier |
| A | B | C | 1 | 2 | 3 | 4 | 5 |

| | | | | |
|---|---|---|---|---|
| Case 1-1 | 1T | 1T | 0T | 1P + (0P + 0P) + (0P + 0P) or 1P + (1P + 0P) + (0P + 0P) or |
| | | | | 1P + (0P + 1P) + (0P + 0P) or 1P + (1P + 1P) + (0P + 0P) or |
| | | | | 0P + (1P + 0P) + (0P + 0P) or 0P + (0P + 1P) + (0P + 0P) or |
| | | | | 0P + (1P + 1P) + (0P + 0P) |
| Case 1-2 | 0T | 1T | 1T | 0P + (0P + 0P) + (1P + 0P) or 0P + (0P + 0P) + (0P + 1P) or |
| | | | | 0P + (0P + 0P) + (1P + 1P) or 0P + (1P + 0P) + (0P + 0P) or |
| | | | | 0P + (1P + 0P) + (1P + 0P) or 0P + (1P + 0P) + (0P + 1P) or |
| | | | | 0P + (1P + 0P) + (1P + 1P) or 0P + (0P + 1P) + (0P + 0P) or |
| | | | | 0P + (0P + 1P) + (1P + 0P) or 0P + (0P + 1P) + (0P + 1P) or |
| | | | | 0P + (0P + 1P) + (1P + 1P) or 0P + (1P + 1P) + (0P + 0P) or |
| | | | | 0P + (1P + 1P) + (1P + 0P) or 0P + (1P + 0P) + (0P + 1P) or |
| | | | | 0P + (1P + 1P) + (1P + 1P) |
| Case 1-3 | 1T | 0T | 1T | 1P + (0P + 0P) + (0P + 0P) or 1P + (0P + 0P) + (1P + 0P) or |
| | | | | 1P + (0P + 0P) + (0P + 1P) or 1P + (0P + 0P) + (1P + 1P) or |
| | | | | 0P + (0P + 0P) + (1P + 0P) or 0P + (0P + 0P) + (0P + 1P) or |
| | | | | 0P + (0P + 0P) + (1P + 1P) or |
| Case 2-2 | 0T | 2T | 0T | 0P + (2P + 0P) + (0P + 0P) or 0P + (0P + 2P) + (0P + 0P) or |
| | | | | 0P + (2P + 2P) + (0P + 0P) or 0P + (1P + 0P) + (0P + 0P) or |
| | | | | 0P + (0P + 1P) + (0P + 0P) or 0P + (1P + 1P) + (0P + 0P) or |
| | | | | 0P + (2P + 1P) + (0P + 0P) or 0P + (1P + 2P) + (0P + 0P) |
| Case 2-3 | 0T | 0T | 2T | 0P + (0P + 0P) + (2P + 0P) or 0P + (0P + 0P) + (2P + 0P) or |
| | | | | 0P + (0P + 0P) + (2P + 2P) or 0P + (0P + 0P) + (1P + 0P) or |
| | | | | 0P + (0P + 0P) + (0P + 1P) or 0P + (0P + 0P) + (1P + 1P) or |
| | | | | 0P + (0P + 0P) + (2P + 1P) or 0P + (0P + 0P) + (2P + 1P) |

### Embodiment 3-3

In this implementation, the uplinkTxSwitchingOption may be set to switchUL and each band in use is associated with two transmission chains assigned. Under this condition, the possible configurations are listed in the Table 13 below.

TABLE 13

| | | | Number of Antenna Port for uplink | | | | |
|---|---|---|---|---|---|---|---|
| Number of | | | transmission | | | | |
| Transmission | | | Band | Band | | Band | |
| Chains | | | A | B | | C | |
| Band | Band | Band | Carrier | Carrier | Carrier | Carrier | Carrier |
| A | B | C | 1 | 2 | 3 | 4 | 5 |

| | | | | |
|---|---|---|---|---|
| Case 2-1 | 2T | 0T | 0T | 2P + (0P + 0P) + (0P + 0P) or 1P + (0P + 0P) + (0P + 0P) or |
| Case 2-2 | 0T | 2T | 0T | 0P + (2P + 0P) + (0P + 0P) or 0P + (0P + 2P) + (0P + 0P) or |
| | | | | 0P + (2P + 2P) + (0P + 0P) or 0P + (1P + 0P) + (0P + 0P) or |
| | | | | 0P + (0P + 1P) + (0P + 0P) or 0P + (1P + 1P) + (0P + 0P) or |
| | | | | 0P + (2P + 1P) + (0P + 0P) or 0P + (1P + 2P) + (0P + 0P) |
| Case 2-3 | 0T | 0T | 2T | 0P + (0P + 0P) + (2P + 0P) or 0P + (0P + 0P) + (2P + 0P) or |
| | | | | 0P + (0P + 0P) + (2P + 2P) or 0P + (0P + 0P) + (1P + 0P) or |
| | | | | 0P + (0P + 0P) + (0P + 1P) or 0P + (0P + 0P) + (1P + 1P) or |
| | | | | 0P + (0P + 0P) + (2P + 1P) or 0P + (0P + 0P) + (2P + 1P) |

### Embodiment 3-4

In this implementation, the uplinkTxSwitchingOption may be set to dualUL and each band is associated with at most two transmission chains assigned. Under this condition, the possible configurations are listed in the Table 14 below.

Similar as Embodiment 1-2, in this embodiment, a switching gap is needed for the uplink transmission switching among Case 1-1, Case 1-2 and Case 1-3.

TABLE 14

| Number of | | | Number of Antenna Port for | | | | |
|---|---|---|---|---|---|---|---|
| Transmission | | | uplink transmission | | | | |
| Chains | | | Band A | Band B | | Band C | |
| Band | Band | Band | Carrier | Carrier | Carrier | Carrier | Carrier |
| A | B | C | 1 | 2 | 3 | 4 | 5 |

| | | | | |
|---|---|---|---|---|
| Case 1-1 | 1T | 1T | 0T | 1P + (0P + 0P) + (0P + 0P) or 1P + (1P + 0P) + (0P + 0P) or |
| | | | | 1P + (0P + 1P) + (0P + 0P) or 1P + (1P + 1P) + (0P + 0P) or |
| | | | | 0P + (1P + 0P) + (0P + 0P) or 0P + (0P + 1P) + (0P + 0P) or |
| | | | | 0P + (1P + 1P) + (0P + 0P) |
| Case 1-2 | 0T | 1T | 1T | 0P + (0P + 0P) + (1P + 0P) or 0P + (0P + 0P) + (0P + 1P) or |
| | | | | 0P + (0P + 0P) + (1P + 1P) or 0P + (1P + 0P) + (0P + 0P) or |
| | | | | 0P + (1P + 0P) + (1P + 0P) or 0P + (1P + 0P) + (0P + 1P) or |
| | | | | 0P + (1P + 0P) + (1P + 1P) or 0P + (0P + 1P) + (0P + 0P) or |
| | | | | 0P + (0P + 1P) + (1P + 0P) or 0P + (0P + 1P) + (0P + 1P) or |
| | | | | 0P + (0P + 1P) + (1P + 1P) or 0P + (1P + 1P) + (0P + 0P) or |
| | | | | 0P + (1P + 1P) + (1P + 0P) or 0P + (1P + 0P) + (0P + 1P) or |
| | | | | 0P + (1P + 1P) + (1P + 1P) |
| Case 1-3 | 1T | 0T | 1T | 1P + (0P + 0P) + (0P + 0P) or 1P + (0P + 0P) + (1P + 0P) or |
| | | | | 1P + (0P + 0P) + (0P + 1P) or 1P + (0P + 0P) + (1P + 1P) or |
| | | | | 0P + (0P + 0P) + (1P + 0P) or 0P + (0P + 0P) + (0P + 1P) or |
| | | | | 0P + (0P + 0P) + (1P + 1P) |
| Case 2-1 | 2T | 0T | 0T | 2P + (0P + 0P) + (0P + 0P) or 1P + (0P + 0P) + (0P + 0P) or |
| Case 2-2 | 0T | 2T | 0T | 0P + (2P + 0P) + (0P + 0P) or 0P + (0P + 2P) + (0P + 0P) or |
| | | | | 0P + (2P + 2P) + (0P + 0P) or 0P + (1P + 0P) + (0P + 0P) or |
| | | | | 0P + (0P + 1P) + (0P + 0P) or 0P + (1P + 1P) + (0P + 0P) or |
| | | | | 0P + (2P + 1P) + (0P + 0P) or 0P + (1P + 2P) + (0P + 0P) |
| Case 2-3 | 0T | 0T | 2T | 0P + (0P + 0P) + (2P + 0P) or 0P + (0P + 0P) + (2P + 0P) or |
| | | | | 0P + (0P + 0P) + (2P + 2P) or 0P + (0P + 0P) + (1P + 0P) or |
| | | | | 0P + (0P + 0P) + (0P + 1P) or 0P + (0P + 0P) + (1P + 1P) or |
| | | | | 0P + (0P + 0P) + (2P + 1P) or 0P + (0P + 0P) + (2P + 1P) |

In some embodiments, the channels between the UE and the BS may include four bands, e.g., Band A to D.

### Embodiments 4-1

In this implementation, the uplinkTxSwitchingOption may be set to switchUL, and Band A is limited to being associated with at most one transmission chain. Under this condition, the possible combinations of number of antenna ports for uplink transmission for some of the entries in Table 2 are listed in the Table 15 below.

TABLE 15

| Number of | | | | Number of Antenna Port for | | | |
|---|---|---|---|---|---|---|---|
| Transmission | | | | uplink transmission | | | |
| Chains | | | | Band A | Band B | Band C | Band D |
| Band | Band | Band | Band | Carrier | Carrier | Carrier | Carrier |
| A | B | C | D | 1 | 2 | 3 | 4 |

| | | | | | |
|---|---|---|---|---|---|
| Case 1-1 | 1T | 1T | 0T | 0T | 1P + 0P + 0P + 0P |
| Case 2-2 | 0T | 2T | 0T | 0T | 0P + 2P + 0P + 0P or 0P + 1P + 0P + 0P |
| Case 2-3 | 0T | 0T | 2T | 0T | 0P + 0P + 2P + 0P or 0P + 0P + 1P + 0P |
| Case 2-4 | 0T | 0T | 0T | 2T | 0P + 0P + 0P + 2P or 0P + 0P + 0P + 1P |

### Embodiment 4-2

In this implementation, the uplinkTxSwitchingOption may be set to dualUL, and Band A is limited to being associated with at most one transmission chain. Under this condition, the possible combinations of number of antenna ports for uplink transmission for some of the entries in Table 2 are listed in the Table 16 below. Additionally, similar to other embodiments in this disclosure, same uplink transmission can be supported under different chain configurations. For example, uplink transmission of 0P+1P+0P+0P may be supported under transmission chain configuration cases 1-1, 1-2, 1-6, and 2-2.

In this embodiment, if the UE is to transmit a 1-port transmission on Carrier 2 on Band B and the preceding transmission was a 1-port transmission on Carrier 1 on Band A or a 1-port transmission on Carrier 3 on Band C under the operation state that 2-port transmission was not supported on Band A and C, i.e., under the operation state in Case 1-3, or under the operation state in Case 1-4, or under the operation state in Case 1-5, then at least one transmission chain from Band A, Band C or Band D should be switched to Band B for the current transmission on Band B. During this switching, a switching gap is introduced, and the UE is not expected to transmit for a duration of the switching gap on any of the carriers on any of the bands. Similar thing would happen if the UE is to transmit a 1-port transmission on Band A and the preceding transmission was under the operation state of Case 1-2, or Case 1-3, or Case 1-6, or if the UE is to transmit a 1-port transmission on Band C and the preceding transmission was under the operation state of Case 1-1, or Case 1-4, or Case 1-6, or if the UE is to transmit a 1-port transmission on Band D and the preceding transmission was under the operation state of Case 1-1, or Case 1-2, or Case 1-5. For all these switching cases, switching gap is introduced and the UE is not expected to transmit for a duration of the switching gap on any of the carriers on any of the bands. In summary, a switching gap is needed for the uplink transmission switching among Case 1-1, Case 1-2, Case 1-3 and Case 1-4.

TABLE 16

| Number of | | | | Number of Antenna Port for | | | |
|---|---|---|---|---|---|---|---|
| Transmission | | | | uplink transmission | | | |
| Chains | | | | Band A | Band B | Band C | Band D |
| Band | Band | Band | Band | Carrier | Carrier | Carrier | Carrier |
| A | B | C | D | 1 | 2 | 3 | 4 |

| | | | | | |
|---|---|---|---|---|---|
| Case 1-1 | 1T | 1T | 0T | 0T | 1P + 0P + 0P + 0P or 1P + 1P + 0P + 0P or |
| | | | | | 0P + 1P + 0P + 0P |
| Case 1-2 | 0T | 1T | 1T | 0T | 0P + 1P + 0P + 0P or 0P + 1P + 1P + 0P or |
| | | | | | 0P + 0P + 1P + 0P |
| Case 1-3 | 0T | 0T | 1T | 1T | 0P + 0P + 1P + 0P or 0P + 0P + 1P + 1P or |
| | | | | | 0P + 0P + 0P + 1P |
| Case 1-4 | 1T | 0T | 0T | 1T | 1P + 0P + 0P + 0P or 1P + 0P + 0P + 1P or |
| | | | | | 0P + 0P + 0P + 1P |
| Case 1-5 | 1T | 0T | 1T | 0T | 1P + 0P + 0P + 0P or 1P + 0P + 1P + 0P or |
| | | | | | 0P + 0P + 1P + 0P |
| Case 1-6 | 0T | 1T | 0T | 1T | 0P + 1P + 0P + 0P or 0P + 0P + 0P + 1P or |
| | | | | | 0P + 0P + 0P + 1P |
| Case 2-2 | 0T | 2T | 0T | 0T | 0P + 2P + 0P + 0P or 0P + 1P + 0P + 0P |
| Case 2-3 | 0T | 0T | 2T | 0T | 0P + 0P + 2P + 0P or 0P + 0P + 1P + 0P |
| Case 2-4 | 0T | 0T | 0T | 2T | 0P + 0P + 0P + 2P or 0P + 0P + 0P + 1P |

### Embodiment 4-3

In this implementation, the uplinkTxSwitchingOption may be set to switchUL, and each band is associated with two transmission chains assigned. Under this condition, the possible combinations of number of antenna ports for uplink transmission for some of the entries in Table 2 are listed in the Table 17 below.

TABLE 17

| | | | | Number of Antenna Port for | | | |
|---|---|---|---|---|---|---|---|
| Number of | | | | uplink transmission | | | |
| Transmission | | | | Band | Band | Band | Band |
| Chains | | | | A | B | C | D |
| Band | Band | Band | Band | Carrier | Carrier | Carrier | Carrier |
| A | B | C | D | 1 | 2 | 3 | 4 |

| | | | | | |
|---|---|---|---|---|---|
| Case 2-1 | 2T | 0T | 0T | 0T | 2P + 0P + 0P + 0P or 1P + 0P + 0P + 0P |
| Case 2-2 | 0T | 2T | 0T | 0T | 0P + 2P + 0P + 0P or 0P + 1P + 0P + 0P |
| Case 2-3 | 0T | 0T | 2T | 0T | 0P + 0P + 2P + 0P or 0P + 0P + 1P + 0P |
| Case 2-4 | 0T | 0T | 0T | 2T | 0P + 0P + 0P + 2P or 0P + 0P + 0P + 1P |

### Embodiment 4-4

In this implementation, the uplinkTxSwitchingOption may be set to dualUL and each band is associated with at most two transmission chains assigned. Under this condition, the possible combinations of number of antenna ports for uplink transmission for each entry in Table 2 are listed in the Table 18 below. Additionally, similar to other embodiments in this disclosure, same uplink transmission can be supported under different chain configurations. For example, uplink transmission of 1P+0P+0P+0P may be supported under transmission chain configuration cases 1-1, 1-4, 1-5 and 2-1.

Similar to embodiment 4-2, in this embodiment, a switching gap is needed for the uplink transmission switching among Case 1-1, Case 1-2, Case 1-3 and Case 1-4.

TABLE 18

| Number of | | | | | | | |
|---|---|---|---|---|---|---|---|
| Transmission | | | | Number of Antenna Port for | | | |
| Chains | | | | uplink transmission | | | |
| Band | Band | Band | Band | Carrier | Carrier | Carrier | Carrier |
| A | B | C | D | 1 | 2 | 3 | 4 |

| | | | | | |
|---|---|---|---|---|---|
| Case 1-1 | 1T | 1T | 0T | 0T | 1P + 0P + 0P + 0P or 1P + 1P + 0P + 0P or |
| | | | | | 0P + 1P + 0P + 0P |
| Case 1-2 | 0T | 1T | 1T | 0T | 0P + 1P + 0P + 0P or 0P + 1P + 1P + 0P or |
| | | | | | 0P + 0P + 1P + 0P |
| Case 1-3 | 0T | 0T | 1T | 1T | 0P + 0P + 1P + 0P or 0P + 0P + 1P + 1P or |
| | | | | | 0P + 0P + 0P + 1P |
| Case 1-4 | 1T | 0T | 0T | 1T | 1P + 0P + 0P + 0P or 1P + 0P + 0P + 1P or |
| | | | | | 0P + 0P + 0P + 1P |
| Case 1-5 | 1T | 0T | 1T | 0T | 1P + 0P + 0P + 0P or 1P + 0P + 1P + 0P or |
| | | | | | 0P + 0P + 1P + 0P |
| Case 1-6 | 0T | 1T | 0T | 1T | 0P + 1P + 0P + 0P or 0P + 0P + 0P + 1P or |
| | | | | | 0P + 0P + 0P + 1P |
| Case 2-1 | 2T | 0T | 0T | 0T | 2P + 0P + 0P + 0P or 1P + 0P + 0P + 0P |
| Case 2-2 | 0T | 2T | 0T | 0T | 0P + 2P + 0P + 0P or 0P + 1P + 0P + 0P |
| Case 2-3 | 0T | 0T | 2T | 0T | 0P + 0P + 2P + 0P or 0P + 0P + 1P + 0P |
| Case 2-4 | 0T | 0T | 0T | 2T | 0P + 0P + 0P + 2P or 0P + 0P + 0P + 1P |

Note that each band above can also be configured with one or two carriers. Although the embodiments for 4 bands are illustrated with one carrier for each band, but they can easily be extended to the case with more than one carriers. The details are not repeated here.

### Transmission Chain Uncertainty Issue

In this embodiment, the BS may configure the UE as to which transmission chain configuration the UE should stay in as explained in the following in case one uplink transmission can be supported under multiple different transmission chain configurations.

The various embodiments above demonstrate the mapping between the transmission chain configurations and number of antenna ports for uplink transmission under various conditions. As mentioned above, in various embodiments, such as embodiment 1-2 and 4-2, same uplink transmission can be supported with various transmission chain configurations. If UE is only triggered to a specified uplink transmission based on a scheduling grant or a configured grant without additional signaling or without any other common understanding, the UE may not be able to determine the transmission chain configuration when such specified uplink transmission takes place.

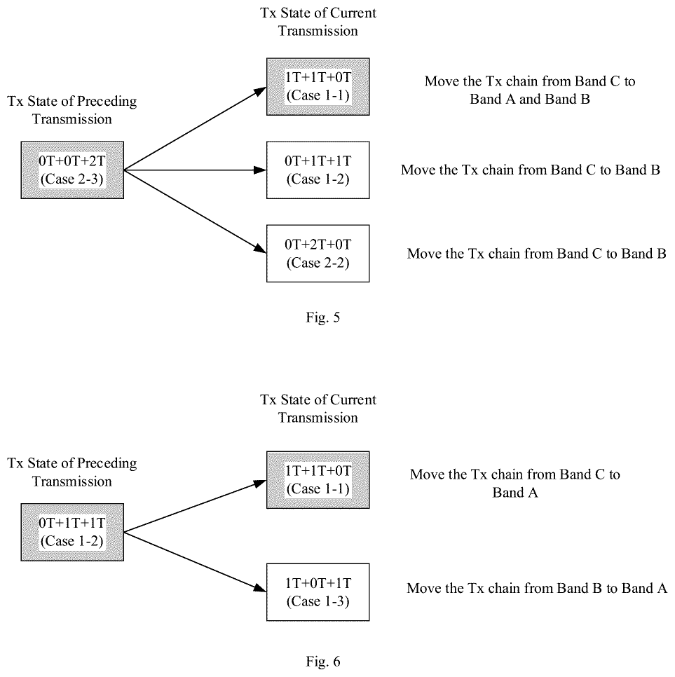

For example, in embodiment 1-2, if the UE is to trigger an uplink transmission of 0P+1P+0P, the UE can implement such an uplink transmission under transmission chain configuration of Case 1-1 (with a transmission chain configuration of 1T+1T+0T), Case 1-2 (with a transmission chain configuration of 0T+1T+1T), or Case 2-2 (with a transmission chain configuration of 0T+2T+0T). Thus, to support an uplink transmission of 0P+1P+0P, non-unique switching may be implemented. For example, the transmission chain switching may include a switch from transmission chain configuration Case 1-3 (1T+0T+1T) to Case 1-1 (1T+1T+0T), a switch from transmission chain configuration Case 1-3 (1T+0T+1T) to Case 1-2 (0T+1T+0T), a switch from transmission chain configuration Case 1-3 (1T+0T+1T) to Case 2-2 (0T+2T+0T), a switch from transmission chain configuration Case 2-3 (0T+0T+2T) to Case 1-1 (1T+1T+0T), a switch from transmission chain configuration Case 2-3 (0T+0T+2T) to Case 1-2 (0T+1T+0T), a switch from transmission chain configuration Case 2-3 (0T+0T+2T) to Case 2-2 (0T+2T+0T), or the like. FIG. 4 and FIG. 5 show the transmission chain switch cases above corresponding to the 0P+1P+0P uplink transmission.

### Radio Resource Control (RRC) Signaling Indication to Solve Uncertainty in Transmission Chain Configuration

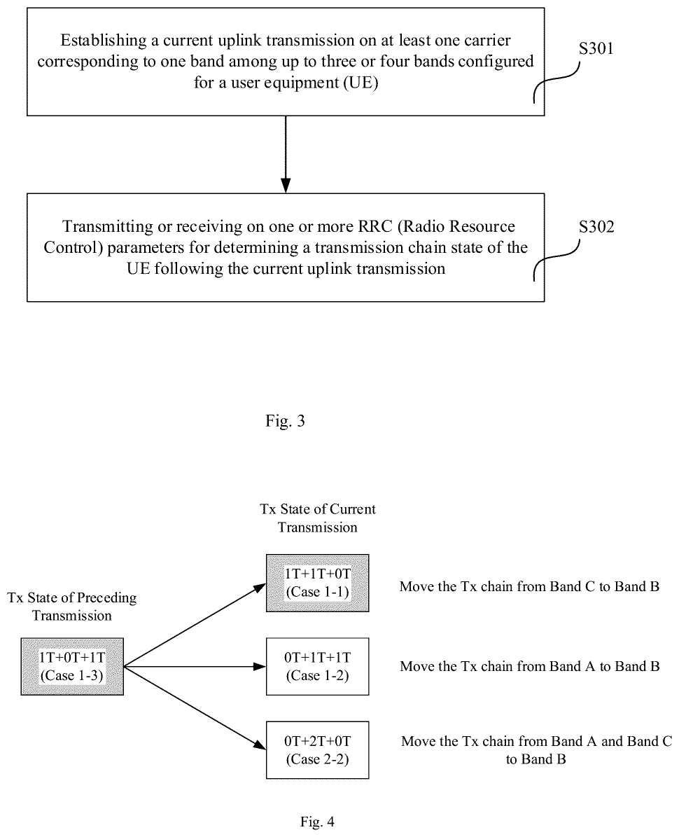

In this implementation, the BS can use one or more RRC (Radio Resource Control) parameters to indicate which transmission chain configuration (or transmission chain state) the UE should stay in following the current uplink transmission. For example, the method to solve the transmission chain configuration ambiguity can include the steps below as shown in FIG. 3:

S301: establishing a current uplink transmission on at least one carrier corresponding to one band among up to three or four bands configured for a user equipment (UE); and

S302: transmitting or receiving on one or more RRC (Radio Resource Control) parameters for determining a transmission chain state of the UE following the current uplink transmission.

For example, in S301, at least three transmission bands are configured for the UE. Optionally, a fourth or more transmission bands can be provided.

For example, in S302, the BS may transmit and the UE may receive one or more RRC (Radio Resource Control) parameters that indicate a transmission chain configuration of the UE, such that the ambiguity among the transmission chain configurations can be resolved.

Using embodiment 1-2 as an example, at least six transmission chain configurations may be defined for solving the ambiguity issue. These five cases are exemplarily shown below.

Case 1-1: 1 transmission chain on Band A and 1 transmission chain on Band B (i.e., 1-port transmission can be supported on both Band A and Band B), or a value labelled with “OneTxOnBandAandBandB” or the like used in the RRC parameters.

Case 1-2: 1 transmission chain on Band B and 1 transmission chain on Band C (i.e., 1-port transmission can be supported on both Band B and Band C), or a value labelled with “OneTxOnBandBandBandC” or the like used in the RRC parameters.

Case 1-3: 1 transmission chain on Band A and 1 transmission chain on Band C (i.e., 1-port transmission can be supported on both Band A and Band C), or a value labelled with “OneTxOnBandAandBandC” or the like used in the RRC parameters.

Case 2-2: 2 transmission chains on Band B (i.e., 2-port transmission can be supported on Band B) or a value labelled with “TwoTxOnBandB” or the like used in the RRC parameters.

Case 2-3: 2 transmission chains on Band C (i.e., 2-port transmission can be supported on Band C) or a value labelled with “TwoTxOnBandC” or the like used in the RRC parameters.

For example, the BS can use one or more RRC parameters to indicate the UE with a specific transmission chain configuration. For example, the one or more RRC parameters can be included in the first signaling or can be included in a second signaling. When multiple RRC parameters are used, each parameter can be used to indicate a subset of all the possible transmission chain configurations.

For example in embodiment 1-2, if one RRC parameter is used, this RRC parameter can be configured in a manner below or the similar:

| | |
|---|---|
| RRC: uplinkTxSwitching-DualUL-TxState | ENUMERATED {OneTxOnBandAandB, |
| | OneTxOnBandBandC, |
| | OneTxOnBandAandC, |
| | TwoTxOnBandB, |
| | TwoTxOnBandC} |

In this example, each value (such as OneTxOnBandAandB, OneTxOnBandAandC . . . , and so on) of the parameter uplinkTxSwitching-DualUL-TxState corresponds to one transmission chain configuration. Thus, when the RRC parameter is used to indicate to the UE what transmission chain configuration it should use, the ambiguity can be resolved. For example, if the RRC is set to “OneTxOnBandAandB” (i.e., Case 1-1), the UE would know that, if 1-port transmission is triggered on Band A, then it should set the transmission chain configuration as Case 1-1. That is, one transmission chain is assigned to Band A and Band B respectively.

Alternatively, the two or more RRC parameters can be used to configure the transmission chain state of the UE, such that the ambiguity can be resolved. For example, the UE can be provided with two RRC parameters, which may be configured according to the following manner or the like:

| | |
|---|---|
| RRC1: uplinkTxSwitching-DualUL-TxState1 | ENUMERATED {OneTxOnBandAandB, |
| | OneTxOnBandBandC, |
| | OneTxOnBandAandC, |
| | } |
| RRC2: uplinkTxSwitching-DualUL-TxState2 | ENUMERATED {TwoTxOnBandB, |
| | TwoTxOnBandC} |

These two RRC parameters may each correspond to a subset of the six candidate transmission chain configurations.

For example, when RRC1 is set to “OneTxOnBandAandB” and RRC2 is set to “TwoTxOnBandC”, (where the UE receives the RRC1 and RRC2 either in the same signaling or two separate signalings), the UE would understands it can use either transmission chain configuration Case 1-1 (corresponding to “OneTxOnBandAandB”) or transmission chain configuration Case 2-3 (corresponding to “TwoTxOnBandC”). Then, UE may determine whether it follows the indication of RRC1 to use Case 1-1 or the indication of RRC2 to use Case 2-3 without ambiguity based on the uplink transmission switching.

For example, if the UE is to trigger a 1-port transmission on Carrier 2 on Band B based on a dynamic scheduling grant or a configured grant, and the preceding transmission was under the operation state with Case 1-3, the UE will follow RRC1 to switch from Case 1-3 to Case 1-1 as shown in FIG. 4. In this case, the UE will switch the transmission chain on Band C to Band B.

If the UE is to trigger a 1-port transmission on Carrier 2 on Band B based on a dynamic scheduling grant or a configured grant, and the preceding transmission was under the operation state with Case 2-3, then the operation state after switch is Case 1-1 following RRC1. In this case, the UE will switch the 2 transmission chains on Band C to Band A and Band B respectively as shown in FIG. 5.

If the UE is triggered to implement 1-port transmission on Band A and the preceding transmission was under the operation state with Case 1-2, the operation state after the switch is Case 1-1 following RRC1. In this case, the UE will switch the transmission chain on Band C to Band A, as shown in FIG. 6.

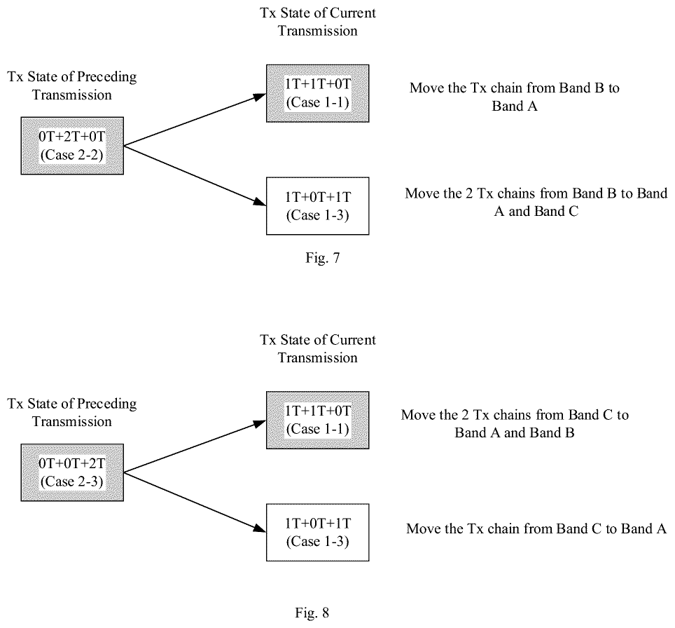

If the UE is triggered to implement 1-port transmission on Band A and the preceding transmission was under the operation state with Case 2-2, then the operation state after the switch is Case 1-1 following RRC1. In this case, the UE will switch the 1 transmission chain on Band B to Band A as shown in FIG. 7.

If the UE is triggered to implement 1-port transmission on Band A and the preceding transmission was under the operation state with Case 2-3, then the operation state after the switch is Case 1-1 following RRC1. In this case, the UE will switch the two transmission chains on Band C to Band A and Band B as shown in FIG. 8.

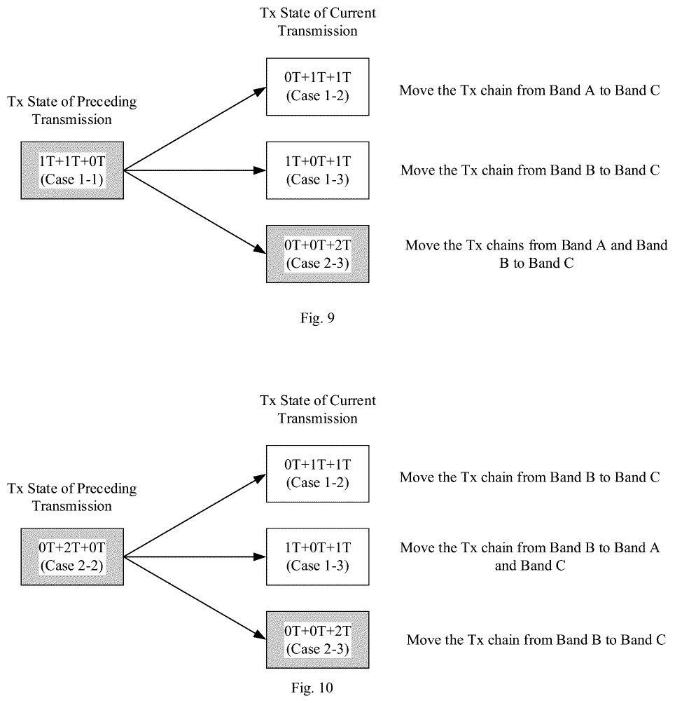

If the UE is triggered to implement 1-port transmission on Band C and the preceding transmission was under the operation state with Case 1-1, then the operation state after switch is Case 2-3 following RRC2. In this case, the UE will switch the transmission chains on Band A and B to Band C as shown in FIG. 9.

If the UE is triggered to implement 1-port transmission on Band C and the preceding transmission was under the operation state with Case 2-2, then the operation state after switch is Case 2-3 following RRC2. In this case, the UE will switch the two transmission chains on Band B to Band C as shown in FIG. 10.

Table 19 below shows the transmission chain configurations that can be associated for different uplink transmission.

TABLE 19

| Uplink transmission | Associated transmission chain configurations |
|---|---|
| 0P + 1P + 0P | Case 1-1, Case 1-2, Case 2-2 |
| 0P + 0P + 1P | Case 1-2, Case 1-3, Case 2-3 |
| 1P + 0P + 0P | Case 1-1, Case 1-3 |

In Table 19, an uplink transmission can be supported and associated with one or more transmission chain configurations. With such associations, the BS can choose a proper transmission chain configuration for a specified uplink transmission.

Additionally in this implementation, the BS may configure the UE's transmission chain configuration according to the target uplink transmission. Using the embodiment 1-2 as an example, if the target uplink transmission is a 1-port transmission on a carrier of Band B, the applicable transmission chain configuration would be cases 1-1, 1-2, and 2-2 because other transmission chain configuration is not compatible with 1-port transmission on a carrier of Band B. In other words, the target uplink transmission that can be triggered is confined with the transmission chain configuration. For example, if the transmission chain configuration is configured to Case 1-1, only 1-port transmission on Band A and/or Band B can be triggered; likewise, 1-port transmission on Band C cannot be supported under this configuration. On the other hand, if the transmission chain configuration is configured to Case 1-1 or Case 2-3 by two RRC parameters, then 1-port transmission on either Band A, B, or C can be supported. The more RRC parameters is provided, the more flexibility can be achieved.

Additionally, the more than one RRC parameters should be set properly to ensure that the UE can solve the ambiguity issue. That is, if RRC1 is set to a specified value, then RRC2 should not set to be a value in the same row with the said specified value as shown in Table 19. For example, if RRC1 is set to Case 1-1, then RRC2 can only be set to Case 2-3. If RRC1 is set to Case 1-2, then RRC2 can only be set to Case 1-1.

### Reduced Transmission Chain Configurations

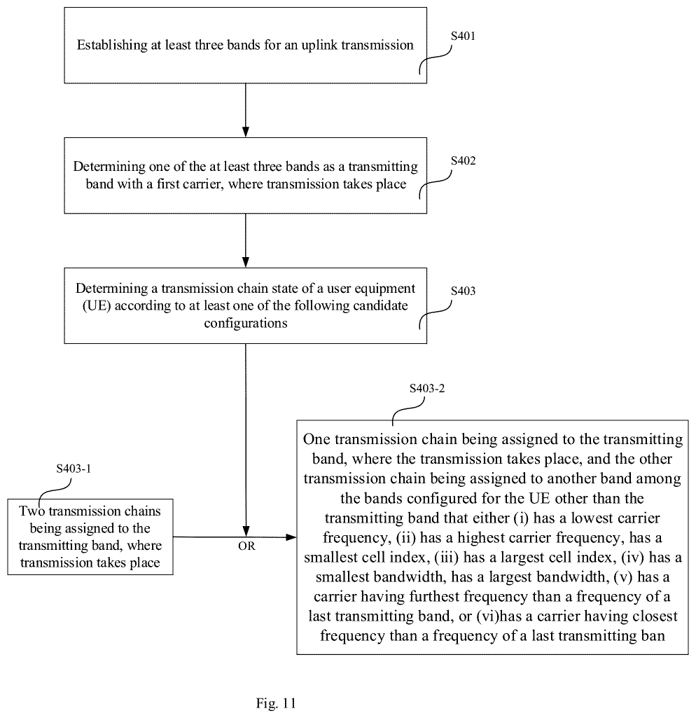

The embodiment above require a plurality of transmission chain configurations, which may increase the system overhead to configure the UE between these states. This disclosure further provide another method as shown in FIG. 11 including:

S401: establishing at least three bands for an uplink transmission;

S402: determining one of the at least three transmission bands as a transmitting band with a first carrier; and

S403: determining a transmission chain state of a user equipment according to at least one of the following candidate configurations:

(S403-1) two transmission chains being assigned to the transmitting band, where transmission takes place, or

(S403-2) one transmission chain being assigned to the transmitting band, where the transmission takes place, and the other transmission chain being assigned to another band among the bands configured for the UE other than the transmitting band which either (i) has a lowest carrier frequency, (ii) has a highest carrier frequency, has a smallest cell index, (iii) has a largest cell index, (iv) has a smallest bandwidth, has a largest bandwidth, (v) has a carrier having furthest frequency than a frequency of a last transmitting band, or (vi) has a carrier having closest frequency than a frequency of a last transmitting band.

In one implementation, the candidate configurations can be one or more predefined rules implement by an agreement between all base stations and user equipment. For example, the agreement can be indicated as: either (1) having two transmission chains being assigned to the transmitting band when a 2-port transmission is to be implemented or (2) having one transmission chain being assigned to the transmitting band, and the other transmission chain being assigned to another band among the bands configured for the UE other than the transmitting band which has a lowest carrier frequency. The lowest carrier frequency is use as an example here, and other predefined rules (i)-(vi) as indicated in (S403-2) can be used.

Alternatively, the rule as defined in (S403-1) and (S403-2) can be adjusted and indicated by the BS with one or more RRC parameters.

For example, the one or more RRC parameters can instruct the UE to:
(1) Configure two transmission chains on the transmitting carrier of the transmitting band; or
(2) Configure one transmission chain on the transmitting carrier of the transmitting band, and configure another remaining transmission chain on another band (based on the preferences indicated in (i)-(vi) in (S403-2)).

Specifically, when there are two transmission chains to be assigned, the two transmission chains can be assigned the one band that is going to be transmitting (the transmitting band). Alternatively, the BS can configure the one of the transmission chains for the transmitting band, and then configure the remaining transmission chain to the rest of the transmission band other than the transmitting band. The remain transmission chain can be assigned based on the rules as defined in (i) to (vi) of (S403-2), and a specific rule among (i) to (vi) can be indicated by the one or more RRC parameters from the BS.

Embodiment 1-2 is used as an example below. When the BS configures the UE to establish a 1-port transmission at Carrier 2 of Band B, (that is, 0P+1P+0P in Table 4), the BS can designate the transmission chain configuration based on the principles (1) and (2) above. For example, the RRC parameter can indicate the UE to follow principles (1) or (2). When the BS indicates that the transmission chain principle as used is principle (1), the UE is configured with Case 2-2 in Table 4. Alternatively, when the BS indicated that the transmission chain principle as used is principle (2), the UE can be configured to switch to the Case 1-1.

In this implementation, the BS may use one or more signalings to indicate how transmission chains can be assigned to the multiple bands. For example, the BS may use an RRC parameter that carry various values, each value corresponding to different principles or rules. With such information, the UE can follow the principle or rule to assign the transmission chain configuration. These principles can be optionally selected.

Alternatively, the predefined rules can be defined as follows:
(p1-1) Configure 2-port transmission on the transmitting carrier of the transmitting band; or
(p2-1) Configure 1-port transmission on the transmitting carrier of the transmitting band, and configure another 1-port transmission on another band having: (p2-1-1) a lowest carrier frequency, (p2-1-2) a highest carrier frequency, (p2-1-3) a smallest cell index, (p2-1-4) a largest cell index, (p2-1-5) a smallest bandwidth, (p2-1-6) a largest bandwidth, (p2-1-7) a carrier frequency closest to the carrier frequency of the last transmitting carrier, or (p2-1-8) a carrier frequency farthest to the carrier frequency of the last transmitting carrier.

In such an implementation, the BS may use one or more signalings to indicate how transmission ports can be assigned to the multiple bands. For example, the BS may use an RRC parameter that carry various values, each value corresponding to principles or rules (p1-1), (p2-1-1) to (p2-1-8). With such information, the UE can follow the principle or rule to assign the 1-port transmission or 2-port transmission on different transmission bands. These principles or rules can be optionally selected.

Additionally, in this implementation, the BS and/or the UE can first determine which band is the transmitting band, and an signaling can be transmitted/received in order to indicate the identity of the transmission band.

The two solutions above (RRC signaling based and predefined rule-based) can be implemented in different embodiments with the ambiguity issue in this disclosure, not just embodiment 1-2. Below uses embodiment 1-4 as another example. According to example 1-4, at least six transmission chain configuration, cases 1-1, 1-2, 1-3, 2-1, 2-2, 2-3 as shown in Table 6 may be considered. For example, the definition of different configuration may be as follows.

Case 1-1: 1 transmission chain on Band A and 1 transmission chain on Band B (i.e., 1-port transmission can be supported on both Band A and Band B), or a value labelled with “OneTxOnBandAandBandB” or the like used in the RRC parameters.

Case 1-2: 1 transmission chain on Band B and 1 transmission chain on Band C (i.e., 1-port transmission can be supported on both Band B and Band C), or a value labelled with “OneTxOnBandBandBandC” or the like used in the RRC parameters.

Case 1-3: 1 transmission chain on Band A and 1 transmission chain on Band C (i.e., 1-port transmission can be supported on both Band A and Band C), or a value labelled with “OneTxOnBandAandBandC” or the like used in the RRC parameters.

Case 2-1: 2 transmission chains on Band A (i.e., 2-port transmission can be supported on Band A), or a value labelled with “TwoTxOnBandA” or the like used in the RRC parameters.

Case 2-2: 2 transmission chains on Band B (i.e., 2-port transmission can be supported on Band B) or a value labelled with “TwoTxOnBandB” or the like used in the RRC parameters.

Case 2-3: 2 transmission chains on Band C (i.e., 2-port transmission can be supported on Band C) or a value labelled with “TwoTxOnBandC” or the like used in the RRC parameters.

For example, in embodiment 1-4, if one RRC parameter is used, this RRC parameter can be configured in the manner or the like below:

| | |
|---|---|
| RRC: uplinkTxSwitching-DualUL-TxState | ENUMERATED {OneTxOnBandAandB, |
| | OneTxOnBandBandC, |
| | OneTxOnBandAandC, |
| | TwoTxOnBandA, |
| | TwoTxOnBandB, |
| | TwoTxOnBandC} |

In the example above, each value (OneTxOnBandAandB, OneTxOnBandAandC, . . . and so on) corresponds to one transmission chain configuration. Thus, when the RRC parameter is used to indicate to the UE what transmission chain configuration it should use, the ambiguity can be resolved. For example, if the RRC is set to “OneTxOnBandAandB” (i.e., Case 1-1), the UE would know that, if 1-port transmission is triggered on Band A, then it should set the transmission chain configuration as Case 1-1. That is, one transmission chain is assigned to Band A and Band B respectively.

Alternatively, the two or more RRC parameters can be used to configure the transmission chain state of the UE for embodiment 1-4, such that the ambiguity can be resolved. For example, the UE can be provided with two RRC parameters, which may be configured according to the following manner or the like:

| | |
|---|---|
| RRC1: uplinkTxSwitching-DualUL-TxState1 | ENUMERATED {OneTxOnBandAandB, |
| | OneTxOnBandBandC, |
| | OneTxOnBandAandC, |
| | } |
| RRC2: uplinkTxSwitching-DualUL-TxState2 | ENUMERATED {TwoTxOnBandA, |
| | TwoTxOnBandB, |
| | TwoTxOnBandC} |

These tow RRC parameters may each correspond to a subset of the six candidate states.

In this example, the parameter RRC1 can correspond to {Case 1-1 (OneTxOnBandAandB), Case 1-2 (OneTxOnBandBandC), Case 1-3 (OneTxOnBandAandC)} and the parameter RRC2 can correspond to case {Case 2-2 (TwoTxOnBandA), Case 2-2 (TwoTxOnBandB), Case 2-3 (TwoTxOnBandC)}.

For example, when RRC1 indicate the Case 1-1 and RRC2 indicates Case 2-3, the UE may decide whether to follow RRC1 or RRC2's indication based on the uplink transmission switching.

For example, if the UE is to have a 1-port transmission on Carrier 2 on Band B and the preceding transmission was under the operation state with Case 1-3, the UE may follow RRC1 to use Case 1-1 because there is no transmission chain assign to Band B under Case 2-3. The corresponding switching is shown in FIG. 4.

If the UE is triggered to implement 1-port transmission on Carrier 2 on Band B and the preceding transmission was under the operation state with Case 2-3, then the operation state after switch is Case 1-1 following RRC1. In this case, the UE will switch the 2 transmission chains on Band C to Band A and Band B respectively as shown in FIG. 5.

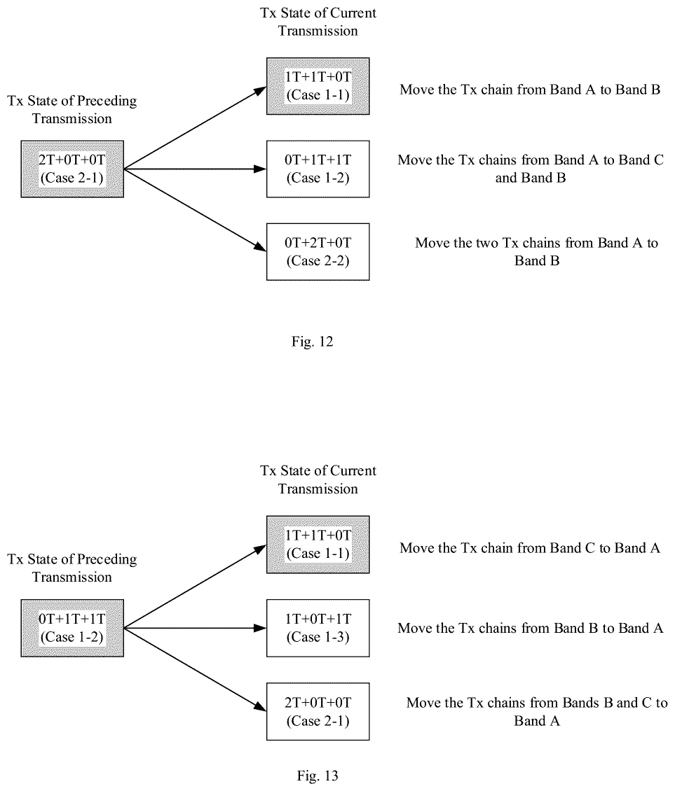

If the UE is to implement 1-port transmission on Carrier 2 on Band B and the preceding transmission was under the operation state with Case 2-1, then the operation state after switch is Case 1-1 following RRC1. In this case, the UE will switch the 2 transmission chains on Band A to Band B, as shown in FIG. 12.

If the UE is to implement 1-port transmission on Carrier 1 on Band A and the preceding transmission was under the operation state with Case 1-2, then the operation state after switch is Case 1-1 following RRC1. In this case, the UE will switch the transmission chain on Band C to Band A, as shown in FIG. 13.

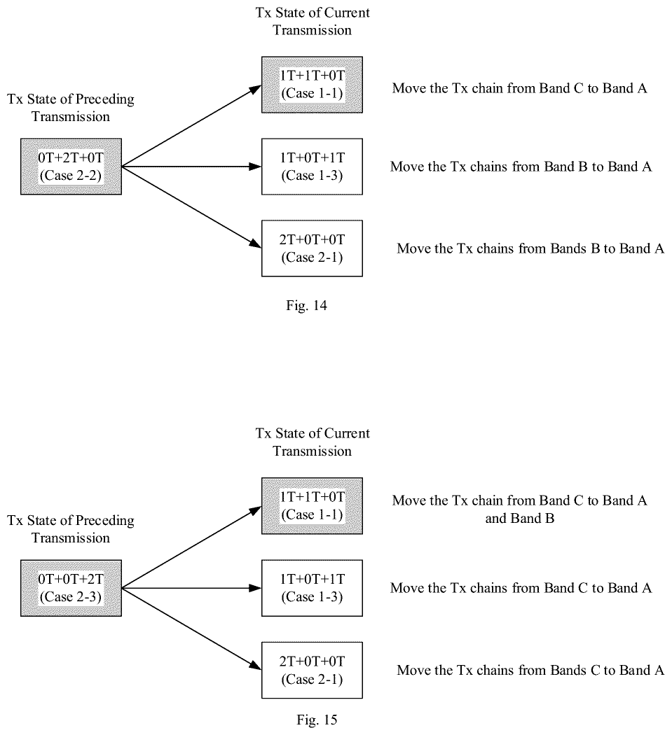

If the UE is to implement 1-port transmission on Carrier 1 on Band A and the preceding transmission was under the operation state with Case 2-2, then the operation state after switch is Case 1-1 following RRC1. In this case, the UE will switch the 1 transmission chains on Band B to Band A, as shown in FIG. 14.

If the UE is to implement 1-port transmission on Carrier 1 on Band A and the preceding transmission was under the operation state with Case 2-3, then the operation state after switch is Case 1-1 following RRC1. In this case, the UE will switch the two transmission chains on Band C to Band A and Band B, as shown in FIG. 15.

If the UE is to implement 1-port transmission on Carrier 3 on Band C and the preceding transmission was under the operation state with Case 1-1, then the operation state after switch is Case 2-3 following RRC2. In this case, the UE will switch the transmission chain on bands A and B to Band C, as shown in FIG. 9.

If the UE is to implement 1-port transmission on Carrier 3 on Band C and the preceding transmission was under the operation state with Case 2-2, then the operation state after switch is Case 2-3 following RRC2. In this case, the UE will switch the two transmission chains on Band B to Band C, as shown in FIG. 10.

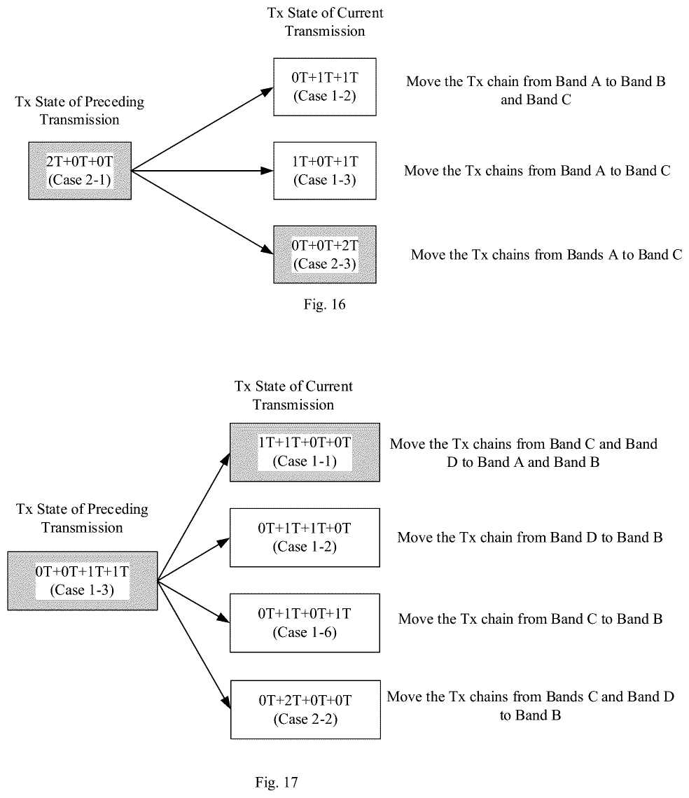

If the UE is to implement 1-port transmission on Carrier 3 on Band C and the preceding transmission was under the operation state with Case 2-1, then the operation state after switch is Case 2-3 following RRC2. In this case, the UE will switch the two transmission chains on Band A to Band C, as shown in FIG. 16.

Additionally, the BS may determine the value of the RRC parameter with the following mapping.

TABLE 20

| uplink transmission | Associated transmission chain configurations |
|---|---|
| 0P + 1P + 0P | Case 1-1, Case 1-2, Case 2-2 |
| 0P + 0P + 1P | Case 1-2, Case 1-3, Case 2-3 |
| 1P + 0P + 0P | Case 1-1, Case 1-3, Case 2-1 |

For example, if the target uplink transmission is a 1-port transmission on a carrier of Band B, i.e., 0P+1P+0P, based on Table 20, the BS uses the RRC parameter(s) to indicate either Case 1-1, Case 1-2, or Case 2-2.

Under embodiment 1-4, the predefined rules (S403-1), (S403-2) and predefined rules or principles (p1-1), (p2-1-1) to (p2-1-8) are still applicable. The BS may use one or more signalings to indicate how transmission port and/or transmission chain can be assigned to the multiple bands under the selected principle or rule.

Below uses embodiment 4-4 as another example. The ambiguity issue can occur on embodiment 4-4 above. For example, if the UE is triggered for 1-port transmission on a carrier of Band B, for example, 0P+1P+0P+0P, the state of transmission chain after the uplink transmission switch is not unique. Specifically, it could either be 1T+1T+0T+0T in Case 1-1, 0T+1T+1T+0T in Case 1-2, 0T+1T+0T+1T in Case 1-6, or 0T+2T+0T+0T in Case 2- 2. For 0P+1P+0P+0P, it can be switched from Case 1-3, Case 1-4, Case 1-5, Case 2-1, Case 2-3, or Case 2-4.

According to embodiment 4-4, 10 transmission chain configurations, Cases 1-1, 1-2, 1-3, 1-4, 1-5, 1-6, 2-1,2-2, 2-3, 2-4 as shown in Table 18 is provided to solve the ambiguity issue. Below is a reiteration of these cases:
Case 1-1: 1 transmission chain on Band A and 1 transmission chain on Band B (i.e., 1-port transmission is transmitted on both Band A and Band B)
Case 1-2: 1 transmission chain on Band B and 1 transmission chain on Band C (i.e., 1-port transmission is transmitted on both Band B and Band C)
Case 1-3: 1 transmission chain on Band C and 1 transmission chain on Band D (i.e., 1-port transmission is transmitted on both Band C and Band D)
Case 1-4: 1 transmission chain on Band A and 1 transmission chain on Band D (i.e., 1-port transmission is transmitted on both Band A and Band D)
Case 1-5: 1 transmission chain on Band A and 1 transmission chain on Band C (i.e., 1-port transmission is transmitted on both Band A and Band C)
Case 1-6: 1 transmission chain on Band B and 1 transmission chain on Band D (i.e., 1-port transmission is transmitted on both Band B and Band D)
Case 2-1: 2 transmission chains on Band B (i.e., 2-port transmission is transmitted on Band A)
Case 2-2: 2 transmission chains on Band B (i.e., 2-port transmission is transmitted on Band B)
Case 2-3: 2 transmission chains on Band C (i.e., 2-port transmission is transmitted on Band C)
Case 2-4: 2 transmission chains on Band D (i.e., 2-port transmission is transmitted on Band D)

For example, in embodiment 4-4, if one RRC parameter is used, this RRC parameter can be configured in the manner or the like below:

| | |
|---|---|
| RRC: uplinkTxSwitching-DualUL-TxState | ENUMERATED {OneTxOnBandAandB, |
| | OneTxOnBandBandC, |
| | OneTxOnBandCandD, |
| | OneTxOnBandAandD, |
| | OneTxOnBandAandC, |
| | OneTxOnBandBandD, |
| | TwoTxOnBandA, |
| | TwoTxOnBandB, |
| | TwoTxOnBandC, |
| | TwoTxOnBandD} |

In the example above, each value (OneTxOnBandAandB, OneTxOnBandBandC, . . . and so on) corresponds to one transmission chain configuration. Thus, when the RRC parameter is used to indicate to the UE what transmission chain configuration it should use, the ambiguity can be resolved. For example, if the RRC is set to “OneTxOnBandAandB” (i.e., Case 1-1), the UE would know that, if 1-port transmission is triggered on Band A, then it should set the transmission chain configuration as Case 1-1. That is, one transmission chain is assigned to Band A and Band B respectively.

Alternatively, the two or more RRC parameters can be used to configure the transmission chain state of the UE for embodiment 4-4, such that the ambiguity can be resolved. For example, the UE can be provided with two RRC parameters, which may be configured according to the following manner or the like:

| | |
|---|---|
| RRC1: uplinkTxSwitching-DualUL-TxState1 | ENUMERATED {OneTxOnBandAandB, |
| | OneTxOnBandBandC, |
| | OneTxOnBandBandD, |
| | TwoTxOnBandA |
| | TwoTxOnBandB |
| | } |
| RRC2: uplinkTxSwitching-DualUL-TxState2 | ENUMERATED {OneTxOnBandCandD, |
| | OneTxOnBandAandD, |
| | OneTxOnBandAandC, |
| | TwoTxOnBandC, |
| | TwoTxOnBandD} |

These two RRC parameters may each correspond to a subset of the 10 candidate transmission chain configurations.

In this example, the parameter RRC1 can correspond to {Case 1-1 (OneTxOnBandAandB), Case 1-2 (OneTxOnBandBandC), Case 1-6 (OneTxOnBandBandD), Case 2-1 (TwoTxOnBandA), Case 2-2 (TwoTxOnBandB)} and the parameter RRC2 can correspond to case {Case 1-3 (OneTxOnBandCandD), Case 1-4 (OneTxOnBandAandD), Case 1-5 (OneTxOnBandAandC), Case 2-3 (TwoTxOnBandC), Case 2-4 (TwoTxOnBandD)}.

For example, when RRC1 indicate the Case 1-1 and RRC2 indicates Case 2-3, the UE may decide whether to follow RRC1 or RRC2's indication based on the uplink transmission switching.

For example, if the UE is to have a 1-port transmission on Carrier 2 on Band B and the preceding transmission was under the operation state with Case 1-3, the UE may follow RRC1 to use Case 1-1 because there is no transmission chain assign to Band B under Case 2-3. The corresponding switching is shown in FIG. 17. In this case, the UE may switch the transmission chains from Band C and D to Band A and B.

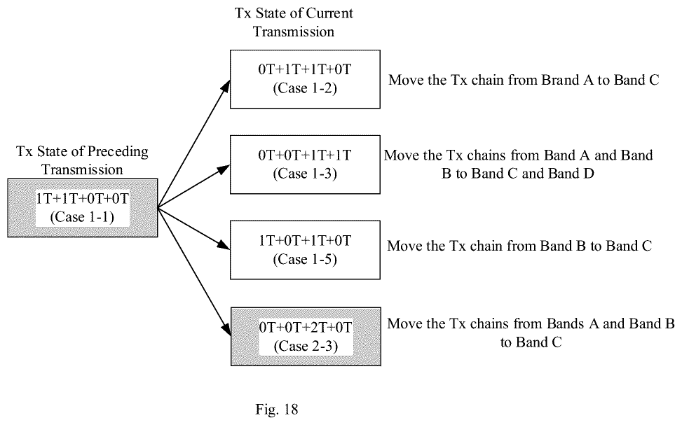

If the UE is to have a 1-port transmission on Carrier 3 on Band C and the preceding transmission was under the operation state with Case 1-1, the UE may follow RRC2 to use Case 2-3 because there is no transmission chain assign to Band C under Case 1-1. The corresponding switching is shown in FIG. 18. In this case, the UE will switch the transmission chains from Band A and B to Band C.

Additionally, the BS may determine the value of the RRC parameter with the following mapping in Table 21.

TABLE 21

| transmission port | Associated transmission chain |
|---|---|
| configuration | configurations |
| 0P + 1P + 0P + 0P | Case 1-1, Case 1-2, Case 1-6, Case 2-2 |
| 0P + 0P + 1P + 0P | Case 1-2, Case 1-3, Case 1-5, Case 2-3 |
| 0P + 0P + 0P + 1P | Case 1-3, Case 1-4, Case 1-6, Case 2-4 |
| 1P + 0P + 0P + 0P | Case 1-1, Case 1-4, Case 1-5, Case 2-1 |

In Table 21, an uplink transmission can be supported and associated with one or more transmission chain configurations. With such associations, the BS can choose a proper transmission chain configuration for a specified uplink transmission.

Additionally in this implementation, the BS may configure the UE's transmission chain configuration according to the target uplink transmission. Using the embodiment 4-4 as an example, if the target uplink transmission is a 1-port transmission on a carrier of Band B, the applicable transmission chain configuration would be cases 1-1, 1-2, 1-6 and 2-2 because other transmission chain configuration is not compatible with 1-port transmission on a carrier of Band B. In other words, the target uplink transmission that can be triggered may be confined with the transmission chain configuration. For example, if the transmission chain configuration is configured to Case 1-1, only 1-port transmission on Band A and/or Band B can be triggered; likewise, 1-port transmission on Band C and Band D cannot be supported under this configuration. On the other hand, if the transmission chain configuration is configured to Case 1-1 or Case 2-3 by two RRC parameters, then 1-port transmission on either Band A, B, or C can be supported. Alternatively, if the transmission chain configuration is configured to Case 1-1 or Case 1-3 by two RRC parameters, then 1-port transmission on either Band A, B, C or D can be supported. Additionally, more RRC parameters, which facilitate more flexibility, can be achieved.

Additionally, the more than one RRC parameters may be set properly to ensure that the UE can solve the ambiguity issue. That is, if RRC1 is set to a specified value, then RRC2 should not be set to be a value in the same row with the said specified value as shown in Table 21. For example, if RRC1 is set to Case 1-1, then RRC2 can be set to Case 1-3, 2-3 or 2-4. If RRC1 is set to Case 1-2, then RRC2 can be set to Cases 1-4, 2-1 or 2-4.

Under embodiment 4-4, the predefined rules (S403-1), (S403-2) and predefined rules (p1-1), (p2-1-1) to (p2-1-8) are still applicable. The BS may use one or more signaling to indicate how transmission port and/or transmission chain can be assigned to the multiple bands.

The Platform

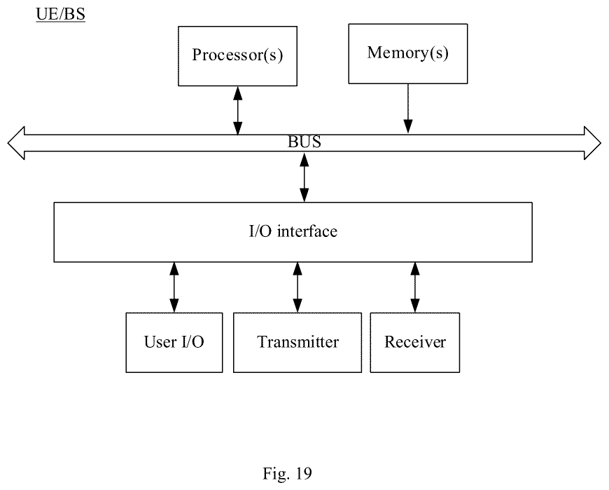

FIG. 19 shows a wireless communication apparatus according to an embodiment of this disclosure. This structure may be used as a UE or a BS. The wireless communication apparatus comprises one or more processors and one or more sets of memory. The memory stores one or more non-transitory computer readable medium programs. The one or more processors can execute the non-transitory computer-readable medium program to perform the method for wireless communication illustrated above. Exemplarily, the wireless communication apparatus may comprise transmitter and receiver to transmit or to receive signals. The wireless communication apparatus may also include user input/output interface to accept user commands.

Further, at least one program may be stored in the memory, which can be transported by a computer program product. The computer program product includes a non-transitory computer-readable program medium code stored thereupon. The code, when executed by at least one processor, causes at least one processor to implement the method for wireless communication program illustrated above.

In some embodiments, the BS can send signaling or information to the UEs (sometimes called down-link transmission), which then enables subsequent communication (e.g., sometimes called uplink direction) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment. The indices, such as bands A, B, C or Case 1-1, 1-2, are for ease of description, and that is not used to limit the scope of such terms. A wireless communication system may use different symbols to distinguish similar elements, but this is still with the scope of this disclosure.

Some of the embodiments described herein are described in the general context of methods or processes, which may be implemented in some embodiments by a computer program product, embodied in a computer-readable medium, including computer-executable instructions, such as program code, executed by computers in networked environments. A computer-readable medium may include volatile and non-volatile storage devices including, but not limited to, digital versatile discs (DVD), compact discs (CDs), Read Only Memory (ROM), Random Access Memory (RAM), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as a Field Programmable Gate Array (FPGA) and/or as an Application Specific Integrated Circuit (ASIC)device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
transmitting a first one-port uplink transmission on at least one of carriers on two corresponding bands by a user equipment (UE), wherein the UE is under an operation state in which a two-port transmission cannot be supported in the two corresponding bands;
withholding uplink transmission from the UE for a time period before a second one-port or two-port uplink transmission is established on one or more other carriers associated with another band other than the two corresponding bands;
establishing the second one-port or two-port second uplink transmission on the one or more other carriers associated with the another band other than the two corresponding bands; and
resuming uplink transmission after the time period.

2. The method of claim 1, further comprising reconfiguring a transmission chain associated with the two corresponding bands to the another band, wherein the transmission chain includes a transmission antenna to perform the second one-port or two-port uplink transmission.

3. The method of claim 1, wherein establishing the first one-port uplink transmission comprises implementing a first configuration, in which the two corresponding bands each is assigned with one transmission chain and the another band is assigned with no transmission chain.

4. The method of claim 3, wherein establishing the second one-port or two-port uplink transmission on the another carrier on the another band comprises switching one or two transmission chains, from the at least one of the two corresponding bands, to the another band.

5. The method of claim 1, wherein the UE is configured with up to three or four bands, and each band has one or two carriers.

6. The method of claim 1, wherein the UE is equipped with two transmission chains.

7. A wireless communication method, comprising:
receiving a first one-port uplink transmission on at least one of carriers on two corresponding bands between a user equipment (UE) and a base station (BS), wherein the UE is under an operation state in which a two-port transmission cannot be supported on the two corresponding bands; and
receiving a second one-port or two-port uplink transmission on one or more carriers associated with another band other than the two corresponding bands after a time period when the UE withheld an uplink transmission.

8. The method of claim 7, wherein a transmission chain associated with the another band is switched from the at least one of the two corresponding bands for the second one-port or two-port uplink transmission.

9. The method of claim 7, wherein each of the two corresponding bands is assigned one transmission chain and the another band is assigned no transmission chain when the first one-port uplink transmission is performed.

10. The method of claim 7, further comprising configuring the UE with up to three or four bands, and each band has one or two carriers.

11. A wireless communication method, comprising:
establishing a current uplink transmission on at least one carrier corresponding to one band among up to three or four bands configured for a user equipment (UE); and
transmitting or receiving on one or more RRC (Radio Resource Control) parameters for determining a transmission chain configuration of the UE following the current uplink transmission.

12. The method of claim 11, wherein the transmission chain state corresponds to an operation state for the UE, and the operation state indicates whether a two-port transmission can be supported or not on one band.

13. The method of claim 11, wherein the RRC parameter is selectable from a set of different values corresponding to a plurality of candidate transmission chain configurations.

14. (canceled)

15. The method of claim 11, wherein the RRC parameters comprise two or more RRC parameters and a value of each RRC parameter is selectable to represent a subset of a plurality of candidate transmission chain configurations.

16. The method of claim 15, wherein a first RRC parameter corresponds to a first subset of candidate transmission chain states and a second RRC parameter corresponds to a second subset of candidate transmission chain configurations.

17. The method of claim 16, wherein a total number of a number of the first subset of candidate transmission chain configurations and the second subset of candidate transmission chain states is not smaller than five, six, nine, or ten.

18. The method of claim 11, wherein the UE is configured with three bands, and the one or more RRC parameters are used for indicating among six candidate transmission chain configurations comprise:
(1) 1 transmission chain being assigned to band A, 1 transmission chain being assigned to band B, and no transmission chain being assigned to band C; or
(2) no transmission chain being assigned to band A, 1 transmission chain being assigned to band B, and 1 transmission chain being assigned to band C; or
(3) 1 transmission chain being assigned to band A, no transmission chain being assigned to band B, and 1 transmission chain being assigned to band C; or
(4) 2 transmission chains being assigned to band A, no transmission chain being assigned to band B, and no transmission chain being assigned to band C;
(5) no transmission chain being assigned to band A, 2 transmission chains being assigned to band B, and no transmission chain being assigned to band C; or
(6) no transmission chain being assigned to band A, no transmission chain being assigned to band B, and 2 transmission chains being assigned to band C.

19. The method of claim 11, wherein the UE is configured with four bands, the one or more RRC parameters are used for indicating among ten candidate transmission chain configurations comprise:
(1) 1 transmission chain being assigned to band A, 1 transmission chain being assigned to band B, no transmission chain being assigned to band C, and no transmission chain being assigned to band D;
(2) no transmission chain being assigned to band A, 1 transmission chain being assigned to band B, 1 transmission chain being assigned to band C, and no transmission chain being assigned to band D;
(3) no transmission chain being assigned to band A, no transmission chain being assigned to band B, 1 transmission chain being assigned to band C, and 1 transmission chain being assigned to band D;
(4) 1 transmission chain being assigned to band A, no transmission chain being assigned to band B, no transmission chain being assigned to band C, and 1 transmission chain being assigned to band D;
(5) 1 transmission chain being assigned to band A, no transmission chain being assigned to band B, 1 transmission chain being assigned to band C, and no transmission chain being assigned to band D;
(6) no transmission chain being assigned to band A, 1 transmission chain being assigned to band B, no transmission chain being assigned to band C, and 1 transmission chain being assigned to band D;
(7) 2 transmission chains being assigned to band A, no transmission chain being assigned to band B, no transmission chain being assigned to band C, and no transmission chain being assigned to band D;
(8) no transmission chain being assigned to band A, 2 transmission chains being assigned to band B, no transmission chain being assigned to band C, and no transmission chain being assigned to band D;
(9) no transmission chain being assigned to band A, no transmission chain being assigned to band B, 2 transmission chains being assigned to band C, and no transmission chain being assigned to band D; or
(10) no transmission chains being assigned to band A, no transmission chain being assigned to band B, no transmission chain being assigned to band C, and 2 transmission chains being assigned to band D.

20.-21. (canceled)

22. A wireless communication apparatus, comprising:
a memory, storing one or more instructions; and
one or more processor, when executing the one or more instructions, configured to cause the wireless communication apparatus to perform the method of claim 1.

23. (canceled)

24. A wireless communication apparatus, comprising:
a memory, storing one or more instructions; and
one or more processor, when executing the one or more instructions, configured to cause the wireless communication apparatus to perform the method of claim 7.
